(19) United States
(12) Patent Application Publication
(10) Pub. No.: US 2021/0395479 A1
(43) Pub. Date: Dec. 23, 2021

(54) HIGH-TEMPERATURE POLYMER AEROGEL COMPOSITES

(71) Applicant: Aerogel Technologies, LLC, Boston, MA (US)

(72) Inventors: Stephen A. Steiner III, Milwaukee, WI (US); Ryan T. Nelson, Medford, MA (US); Justin S. Griffin, Watertown, MA (US)

(73) Assignee: Aerogel Technologies, LLC, Boston, MA (US)

(21) Appl. No.: 17/279,523

(22) PCT Filed: Sep. 25, 2019
(86) PCT No.: PCT/US2019/053011

§ 371 Date: Mar. 24, 2021

Related U.S. Application Data
(60) Provisional application No. 62/735,881, filed on Sep. 25, 2018.
(60) Provisional application No. 62/736,282, filed on Sep. 25, 2018.

(51) Int. Cl. C08J 9/00; C08J 9/28; B01J 13/00

(52) U.S. Cl. CPC C08J 9/0085; C08J 9/286; B60R 13/0838; C08J 2379/08; C08J 2205/026; B01J 13/0091

(57) ABSTRACT

High-temperature polymer aerogel composites, associated materials, associated methods of manufacture, and applications of polymer aerogel composites including engine covers comprising aerogel materials are generally described.

### RELATED APPLICATIONS

This application claims priority under 35 U.S.C. § 119(e) to U.S. Provisional Application No. 62/735,881, filed Sep. 25, 2018, and entitled “Aerogel Engine Covers,” and to U.S. Provisional Application No. 62/736,282, filed Sep. 25, 2018, and entitled “Aerogel Engine Covers,” each of which is incorporated herein by reference in its entirety for all purposes.

### TECHNICAL FIELD

High-temperature polymer aerogel composites, associated materials, associated methods of manufacture, and applications of polymer aerogel composites including engine covers comprising aerogel materials are generally described.

### SUMMARY

High-temperature polymer aerogel composites, associated materials, associated methods of manufacture, and applications of polymer aerogel composites including engine covers comprising aerogel materials are generally described. The subject matter of the present invention involves, in some cases, interrelated products, alternative solutions to a particular problem, and/or a plurality of different uses of one or more systems and/or articles.

Certain embodiments relate to an aerogel composite. In some embodiments, the aerogel composite comprises a polymer aerogel and a fibrous batting located at least partially within outer bounds of the polymer aerogel; wherein, when a sample of the aerogel composite with dimensions of 6.5 cm×2.0 cm×0.5 cm and/or the aerogel composite itself, initially at a temperature of 25 deg. C., is transferred from an environment at 25 deg. C. and 1 atm pressure of air into an evenly-heated oven at a temperature of 200 deg. C. and 1 atm pressure of air and is left in the oven for a period of 60 minutes, a length of at least one dimension of the sample and/or the aerogel composite does not shrink or shrinks by less than 10% relative to its length prior to the heating.

In some embodiments, the aerogel composite comprises a polyimide aerogel and a fibrous batting located at least partially within outer bounds of the polyimide aerogel, wherein the polyimide aerogel comprises a polyimide oligomer component, and wherein the polyimide oligomer component is connected to another polyimide oligomer component by a crosslinker.

Certain aspects are related to methods of making aerogel composites. In some embodiments, the method comprises removing liquid from a gel within which a fibrous batting is at least partially contained to form an aerogel composite comprising a polyimide aerogel and the fibrous batting, wherein, when a sample of the aerogel composite with dimensions of 6.5 cm×2.0 cm×0.5 cm and/or the aerogel composite itself, initially at a temperature of 25 deg. C., is transferred from an environment at 25 deg. C. and 1 atm pressure of air into an evenly-heated oven at a temperature of 200 deg. C. and 1 atm pressure of air and is left in the oven for a period of 60 minutes, a length of at least one dimension of the sample and/or the aerogel composite does not shrink or shrinks by less than 10% relative to its length prior to the heating.

In certain embodiments, the method comprises removing liquid from a gel within which a fibrous batting is at least partially contained to form an aerogel composite comprising a polyimide aerogel and the fibrous batting, wherein the polyimide aerogel comprises a polyimide oligomer component, and wherein the polyimide oligomer component is connected to another polyimide oligomer component by a crosslinker.

Some embodiments are related to compositions of matter. In some embodiments, the composition of matter comprises a fibrous batting and a polymer aerogel.

Certain embodiments are related to porous crosslinked polyimide networks. In some embodiments, the porous crosslinked polyimide network comprises an anhydride end-capped polyamic acid oligomer, wherein the oligomer (i) comprises a repeating unit of a dianhydride and a diamine and terminal anhydride groups, (ii) has an average degree of polymerization of 10 to 50, (iii) has been crosslinked via a crosslinking agent, comprising three or more amine groups, at a balanced stoichiometry of the amine groups to the terminal anhydride groups, and (iv) has been chemically imidized to yield the porous crosslinked polyimide network.

Some embodiments are related to vehicle engine covers. In some embodiments, the vehicle engine cover comprises a fibrous batting and polymer aerogel.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the drawings:

FIG. 1 depicts a cross-sectional schematic illustration of a composite, according to certain embodiments;

FIG. 2 depicts a perspective view of a polymer aerogel composite in accordance with certain embodiments;

FIG. 3 depicts a polymer aerogel composite before and after heating to 350° C. and a polymer aerogel reference material (i.e., the same formulation of aerogel used in producing the composite) before and after heating to 300° C. in accordance with certain embodiments;

FIG. 4 is a graph of bulk density vs. anneal temperature for a polymer aerogel composite and the reference unreinforced aerogel material shown in FIG. 3 in accordance with certain embodiments;

FIG. 5 is a graph showing the specific surface area of a polymer aerogel composite vs. the temperature at which it was annealed in accordance with certain embodiments;

FIG. 6 is a graph of thermal conductivity at room temperature vs. the temperature at which the sample was annealed for a polyimide aerogel/carbon felt composite in accordance with certain embodiments;

FIG. 7 is an image of a polymer aerogel composite during mechanical flexure testing in the jaws of a three-point-bend fixture in accordance with certain embodiments;

FIG. 8 is an image of a polymer aerogel/meta-aramid felt composite during mechanical flexure testing in the jaws of a three-point-bend fixture, shown from a vantage point below the fixture in accordance with certain embodiments;

FIG. 9 is an image of a polymer aerogel/meta-aramid felt composite during mechanical flexure that is induced by a human hand in accordance with certain embodiments; and

FIG. 10 is a graph of the stress vs. strain curve for the outer member of two samples in flexure, namely a polymer aerogel/carbon felt composite and an unreinforced polymer aerogel equivalent to that contained within the composite in accordance with certain embodiments.

### DETAILED DESCRIPTION

Aerogels are a diverse class of low-density solid materials comprised of a porous three-dimensional solid-phase network. Aerogels often exhibit a wide array of desirable materials properties including high specific surface area, low bulk density, high specific strength and stiffness, low thermal conductivity, and/or low dielectric constant, among others.

Certain aerogel compositions may combine several such properties into the same material envelope and may thus be advantageous for applications including thermal insulation, acoustic insulation, lightweight structures, electronics, impact damping, electrodes, catalysts and/or catalyst supports, and/or sensors. Some aerogel materials also possess mechanical properties that make them suitable for use as structural materials and, for example, can be used as lightweight alternatives to plastics.

Aerogels can be made of a variety of materials and can exhibit a number of geometries. Generally speaking, aerogels are dry, highly porous, solid-phase materials that may exhibit a diverse array of extreme and valuable materials properties, e.g., low density, low thermal conductivity, high density-normalized strength and stiffness, and/or high specific internal surface area. In some embodiments, the pores within an aerogel material are less than about 100 nm in diameter, while in some preferred embodiments, the diameter of the pores within an aerogel material fall between about 2-50 nm in diameter, i.e., the aerogel is mesoporous. In some embodiments, aerogels may contain pores with diameters greater than about 100 nm, and in some embodiments aerogels may even contain pores with diameters of several microns. In some embodiments, at least 50%, at least 60%, at least 70%, at least 80%, at least 90%, at least 95%, at least 99%, or more of the pore volume is made up of pores having diameters of less than 100 nm. In some embodiments, at least 50%, at least 60%, at least 70%, at least 80%, at least 90%, at least 95%, at least 99%, or more of the pore volume is made up of pores having diameters of less than 50 nm. In some preferred embodiments, at least 50%, at least 60%, at least 70%, at least 80%, at least 90%, at least 95%, at least 99%, or more of the pore volume is made up of pores having diameters of less than 25 nm. In some embodiments, an aerogel may contain a monomodal distribution of pores, a bimodal distribution of pores, or a polymodal distribution of pores. Suitable aerogel material compositions may include, for example, silica, metal and/or metalloid oxides, metal chalcogenides, metals and/or metalloids, metal and/or metalloid carbides, metal and/or metalloid nitrides, organic polymers, biopolymers, amorphous carbon, graphitic carbon, diamond, and discrete nanoscale objects such as carbon nanotubes, boron nitride nanotubes, viruses, semiconducting quantum dots, graphene, 2D boron nitride, or combinations thereof.

In accordance with certain embodiments, aerogel materials may be made from a precursor gel material. For example, some embodiments comprise arranging a fibrous batting within an aerogel precursor material, forming a gel, and removing liquid from the gel to form a composite comprising a polymer aerogel and the fibrous batting. Various methods of forming aerogels are described below and elsewhere herein, and it should be understood that, wherever formation of aerogels is described, fibrous batting may be present within the material from which the aerogel is formed (e.g., the gel, the gel precursor, etc.) such that the formation of the aerogel results in the formation of a composite material comprising the fibrous batting and the aerogel. Similarly, various methods of forming aerogel precursors (e.g., gels) are described below and it should be understood that, wherever formation of aerogel precursors is described, fibrous batting may be present within the material from which the aerogel precursor is formed such that the formation of the aerogel precursor results in the formation of a composite material comprising the fibrous batting and the aerogel precursor.

As provided herein, a gel is a colloidal system in which a porous, solid-phase network spans the volume occupied by a liquid medium. Accordingly, gels have two components: a sponge-like solid skeleton, which may give the gel its solid-like cohesiveness, and a liquid that permeates the pores of that skeleton.

Gels of different compositions may be synthesized through a number of methods, which may include a sol-gel process. One of ordinary skill in the art is familiar with the sol-gel process. The sol-gel process involves the production of sol, i.e., a colloidal suspension of very small solid particles that are dispersed in a continuous liquid medium in (e.g., nanoparticles, nanotubes, nanoplatelettes, graphene, nanophase oligomers or polymer aggregates). The very small solid particles may be formed in situ, for example, by performing a polymerization reaction in a solution, or formed ex situ and dispersed in the liquid. Following and potentially concurrently with preparation of a sol, the sol-gel process then involves interconnection of the particles in the sol (e.g., through covalent or ionic bonding, polymerization, physisorption, or other mechanisms) to form a three-dimensional network, forming a gel.

Aerogels may be fabricated by removing the liquid from a gel in a way that substantially preserves both the porosity and integrity of the gel's intricate nanostructured solid network. For most gel materials, if the liquid in the gel is evaporated, capillary stresses will arise as the vapor-liquid interface recedes into or from the gel, causing the gel's solid network to shrink or pull inwards on itself, and collapse. The resulting material is a dry, comparatively dense, low-porosity (generally <10% by volume) material that is often referred to as a xerogel material, or solid formed from the gel by drying with unhindered shrinkage. However, the liquid in the gel may instead be heated and pressurized past its critical point, a specific temperature and pressure at which the liquid will transform into a semi-liquid/semi-gas, or supercritical fluid, that exhibits little surface tension, if at all. Below the critical point, the liquid is in equilibrium with a vapor phase. As the system is heated and pressurized towards its critical point, however, molecules in the liquid develop an increasing amount of kinetic energy, moving past each other increasingly fast until eventually their kinetic energy exceeds the intermolecular adhesion forces that give the liquid its cohesion. Simultaneously, the pressure in the vapor also increases, bringing molecules on average closer together until the density of the vapor becomes nearly and/or substantially as dense as the liquid phase. As the system reaches the critical point, the liquid and vapor phases become substantially indistinguishable and merge into a single phase that exhibits a density and thermal conductivity comparable to a liquid, yet is also able to expand and compress in a manner similar to that of a gas. Although technically a gas, the term supercritical fluid may refer to fluids near and/or past their critical point as such fluids, due to their density and kinetic energy, exhibit liquid-like properties that are not typically exhibited by ideal gases, for example, the ability to dissolve other substances. Since phase boundaries do not typically exist past the critical point, a supercritical fluid exhibits no surface tension and thus exerts no capillary forces, and can be removed from a gel without causing the gel's solid skeleton to collapse by isothermal depressurization of the fluid. After fluid removal, the resulting dry, low-density, high-porosity material is an aerogel.

The critical point of most substances typically lies at relatively high temperatures and pressures, thus, supercritical drying generally involves heating gels to elevated temperatures and pressures and hence is performed in a pressure vessel. For example, if a gel contains ethanol as its pore fluid, the ethanol can be supercritically extracted from the gel by placing the gel in a pressure vessel containing additional ethanol, slowly heating the vessel past the critical temperature of ethanol (241° C.), and allowing the autogenic vapor pressure of the ethanol to pressurize the system past the critical pressure of ethanol (60.6 atm). At these conditions, the vessel can then be quasi-isothermally depressurized so that the ethanol diffuses out of the pores of the gel without recondensing into a liquid. Likewise, if a gel contains a different solvent in its pores, the vessel may be heated and pressurized past the critical point of that solvent. Extraction of organic solvent from a gel requires specialized equipment, however, since organic solvents at their critical points can be dangerously flammable and explosive. Instead of supercritically extracting an organic solvent directly from gel, the liquid in the pores of the gel may instead first be exchanged with liquid carbon dioxide, which is miscible with most organic solvents, is nonflammable, and can subsequently be supercritically extracted above its relatively low critical point of 31.1° C. and 72.9 atm. This process, called supercritical CO₂ drying, is commonly employed in the manufacture of aerogel materials. In accordance some embodiments described herein, supercritical CO₂ drying may be used to make aerogels and/or polymer aerogel composites.

In some embodiments, aerogels may be fabricated by removing the liquid from a gel by evaporative drying of the solvent. In some embodiments, the pore fluid exhibits a sufficiently low surface tension to prevent damaging the gel and/or gel/fibrous batting composite, for example, less than about 20 dynes/cm, less than about 15 dynes/cm, less than about 12 dynes/cm, or less than about 10 dynes/cm. In certain embodiments, the surface tension of the solvent is equal to or less than 20 dynes/cm, equal to or less than 15 dynes/cm, equal to or less than 12 dynes/cm, or equal to or less than 10 dynes/cm. Combinations of these ranges are also possible (e.g., at least 5 and less than or equal to 25). Other ranges are also possible. In some preferred embodiments, the pore fluid selected for evaporative drying is ethoxynonafluorobutane (e.g., Novec 7200). In some embodiments, the solvent is evaporated at room temperature. In some preferred embodiments, the solvent is evaporated in an atmosphere of dry air (i.e., substantially water-free), nitrogen, and/or another substantially water-free inert gas. In other preferred embodiments, the pore fluid selected for evaporative drying is carbon dioxide at a temperature below the critical temperature and pressure of carbon dioxide of approximately 31.1° C. and 72.8 atm (1071 psi). In one such embodiment, the gel is evaporatively dried from liquid carbon dioxide at a temperature of approximately 28° C. and a pressure of about 68.0 atm (1000 psi).

In some embodiments, aerogels may be fabricated from gels by sublimation of a frozen pore fluid rather than evaporation of liquid-phase pore fluid. The pore fluid may be suitably frozen and sublimated with little to no capillary force, resulting in an aerogel. That is, rather than removing the solvent via evaporation from a liquid state, the solvent is sublimated from a solid state (having been frozen), hence, minimizing capillary forces that may otherwise result via evaporation. In some embodiments, the sublimation of the frozen pore fluid is performed under vacuum, or partial vacuum conditions, e.g., lyophilization. In some embodiments, the sublimation of the frozen pore fluid is performed at atmospheric pressure. In some embodiments, the method includes providing a gel material having a solvent located within pores of the gel material, freezing the solvent within the pores of the gel material, and sublimating the solvent at ambient conditions to remove the solvent from the pores of the gel material to produce an aerogel material. In some embodiments, the sublimation of the solvent is performed in dry (i.e., substantially water-free) air, nitrogen, and/or another substantially water-free inert gas. In a further preferred embodiment, the pore fluid selected for this process is tert-butanol.

In some embodiments, an aerogel may be a polymer aerogel. A polymer aerogel is an aerogel that is at least partially made out of a polymeric material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polymer. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of organic polymer, i.e., a polymer having carbon atoms in its backbone.

In some embodiments, the polymer aerogel comprises polyurea, a polyurethane, a polyisocyanate, a polyisocyanurate, a polyimide, a polyamide, a poly(imide-amide), a polyacrylonitrile, a polycyclopentadiene, a polybenzoxazine, a polybenzazazine, a polyacrylamide, a polynorbornene, a poly(ethylene terephthalate), a poly(ether ether ketone), a poly(ether ketone ketone), a phenolic polymer, a resorcinol-formaldehyde polymer, a melamine-formaldehyde polymer, a resorcinol-melamine-formaldehyde polymer, a furfural-formaldehyde polymer, a resole, a novolac, an acetic-acid-based polymer, a polymer-crosslinked oxide, a silica-polysaccharide polymer, a silica-pectin polymer, a polysaccharide, a glycoprotein, a proteoglycan, collagen, a protein, a polypeptide, a nucleic acid, amorphous carbon, graphitic carbon, graphene, diamond, a carbon nanotube, boron nitride, a boron nitride nanotube, two-dimensional boron nitride, an alginate, a chitin, a chitosan, a pectin, a gelatin, a gelan, a gum, an agarose, an agar, a cellulose, a virus, a biopolymer, an ormosil, an organic-inorganic hybrid material, a rubber, a polybutadiene, a poly(methyl pentene), a polyester, a polyether ether ketone, a polyether ketone ketone, a polypentene, a polybutene, a polytetrafluoroethylene, a polyethylene, a polypropylene, a polyolefin, a metal nanoparticle, a metalloid nanoparticle, a metal chalcogenide, a metalloid chalcogenide, a metal, a metalloid, a metal carbide, a metalloid carbide, a metal nitride, a metalloid nitride, a metal silicide, a metalloid silicide, a metal phosphide, a metalloid phosphide, a phosphorous-containing organic polymer, and/or a carbonizable polymer.

In some embodiments, polymer aerogels comprising an organic polymer may provide certain advantages over more commercially widespread inorganic aerogels such as silica aerogels. For example, silica aerogels often exhibit low fracture toughness and are accordingly brittle and friable. As a result, most silica aerogel materials are generally considered unsuitable for use as structural elements. In some embodiments, polymer aerogels comprising an organic polymer may exhibit improved strength, stiffness, and toughness properties over silica aerogels and thus may be used in lightweight structural elements as an alternative to traditional plastics or fiber-reinforced composites, which are much denser in comparison.

In some embodiments, the polymer aerogel may be a polyimide aerogel. A polyimide aerogel is an aerogel that is at least partially made out of a polyimide material. In some embodiments, at least 25 wt %, at least 50 wt %, at least 75 wt %, at least 90 wt %, at least 95 wt %, at least 98 wt %, at least 99 wt %, at least 99.9 wt %, or all of the polymer aerogel is made of polyimide. In some embodiments, polyimide aerogels may exhibit one or more materials properties of particular value to engineering applications.

In some embodiments, a polyurea gel suitable for making a polyurea aerogel is prepared. In some embodiments, a polyurea gel is derived from the reaction of an isocyanate with water, wherein amines are formed in situ. In some embodiments, the polyurea gel is derived from the reaction of an isocyanate with an amine. In some embodiments, the polyurea gel comprises an aromatic group. In some embodiments, the polyurea gel comprises isocyanurate. In some embodiments, the polyurea gel comprises flame retardant moieties, e.g., bromides, bromates, phosphates. In some embodiments, an isocyanate is used to make the solid phase of a polyurea gel material. In some preferred embodiments, the isocyanate comprises hexamethylenediisocyanate, Desmodur® N3200, Desmodur N3300, Desmodur N100, Desmodur N3400, Desmodur RE, Desmodur RC, tris(isocyanatophenyl)methane, Mondur® MR, Mondur MRS, a methylene diphenyl diisocyanate, diphenylmethane 2,2′-, 2,4′- and/or 4,4′-diisocyanate (MDI), naphthylene 1,5-diisocyanate (NDI), a toluene diisocyanate, toluene 2,4- and/or 2,6-diisocyanate (TDI), 3,3′-dimethylbiphenyl diisocyanate, 1,2-diphenylethane diisocyanate and/or p-phenylene diisocyanate (PPDI), trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and dicyclohexylmethane 4,4′-, 2,4′- and/or 2,2′-diisocyanate. In some embodiments, an amine is used to make the solid phase of a polyurea gel material. In some preferred embodiments, the amine comprises 4,4′-oxydianiline, 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenyl sulfones, 1,3-bis(4-aminophenoxy)benzene, 1,3-bis(3-aminophenoxy)benzene, 1,4-bis(4-aminophenoxy)benzene, 1,4-bis(3-aminophenoxy)benzene, 2,2-bis[4-(4-aminophenoxy)phenyl]hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis[4-(4-aminophenoxy)phenyl]sulfones, 2,2-bis[4-(3-aminophenoxy)phenyl]sulfones, bis(4-[4-aminophenoxy]phenyl)ether, 2,2′-bis(4-aminophenyl)-hexafluoropropane, (6F-diamine), 2,2′-bis(4-phenoxyaniline)isopropylidene, m-phenylenediamine, p-phenylenediamine, 1,2-diaminobenzene, 4,4′-diaminodiphenylmethane, 2,2-bis(4-aminophenyl)propane, 4,4′diaminodiphenylpropane, 4,4′-diaminodiphenylsulfide, 4,4′-diaminodiphenylsulfone, 3,4′-diaminodiphenyl ether, 4,4′-diaminodiphenyl ether, 2,6-diaminopyridine, bis(3-aminophenyl)diethyl silane, 4,4′-diaminodiphenyldiethyl silane, benzidine, dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-β-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-methylene-bis(2-methylcyclohexylamine), 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-methylene-bis-benzeneamine, 2,2′-bis[4-(4-aminophenoxy)phenyl]propane, 2,2′-dimethylbenzidine, bisaniline-p-xylidene, 4,4′-bis(4-aminophenoxy) biphenyl, 3,3′-bis(4-aminophenoxy)biphenyl, 4,4′-(1,4-phenylenediisopropylidene)bisaniline, 4,4′-(1,3-phenylenediisopropylidene) bisaniline. In some embodiments, a polyurea aerogel may be made from a suitable polyurea gel using any suitable drying technique, for example, supercritical CO₂ drying, evaporative drying, or freeze drying.

In some embodiments, a polyamide gel suitable for making a polyamide aerogel is prepared. In some embodiments, a polyamide gel is derived from the reaction of one or more diacid chlorides with one or more diamines. In some embodiments, this reaction forms amine capped oligomers. In some embodiments, these oligomers can be crosslinked using 1,3,5-benzenetricarbonyl trichloride to yield a porous, highly crosslinked polyamide network. In some preferred embodiments, amine end-capped oligomers are synthesized from m-phenylene diamine (mPDA) and diacid chloride in NMP and crosslinked with benzenetricarbonyl trichloride (BTC). In some further preferred embodiments, isophthaloyl chloride (IPC) and or terephthaloyl chloride (TPC) can be combined with m-phenylene diamine (mPDA) in N-methylpyrrolidinone (NMP), to give amine capped polyamide oligomers formulated with between 20 and 40 repeat units (in some embodiments, however, depending on selection of materials, oligomers can be formulated with less than 20 or greater than 40 repeat units, including but not limited to examples provided herein). In some embodiments the reaction of diacid chlorides and amines generates acyl chloride terminated oligomers. In some embodiments, the oligomers are crosslinked by a crosslinking agent. In some embodiments, the terminal end group on the oligomer reacts with a polyfunctional crosslinking agent, which then reacts with the terminal end group on at least one other oligomer. In some embodiments, the crosslinking agent comprises a triamine; an aliphatic triamine; an aromatic amine comprising three or more amine groups; an aromatic triamine; 1,3,5-tris(aminophenoxy)benzene (TAB); tris(4-aminophenyl)methane (TAPM); tris(4-aminophenyl)benzene (TAPB); tris(4-aminophenyl)amine (TAPA); 2,4,6-tris(4-aminophenyl)pyridine (TAPP); 4,4′,4″-methanetriyltrianiline; N,N,N′,N′-tetrakis(4-aminophenyl)-1,4-phenylenediamine; a polyoxypropylenetriamine; N′,N′-bis(4-aminophenyl)benzene-1,4-diamine; a triisocyanate; an aliphatic triisocyanate; an aromatic isocyanate comprising three or more isocyanate groups; an aromatic triisocyanate; a triisocyanate based on hexamethylene diisocyanate; the trimer of hexamethylene diisocyanate; hexamethylenediisocyanate; a polyisocyanate; a polyisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodur blulogiq 3190; Desmodur XP 2860; Desmodur N3400; Desmodur XP 2840; Desmodur N3580 BA; Desmodur N3500; Desmodur RE; tris(isocyanatophenyl)methane; Desmodur RC; Mondur® MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/or p-phenylene diisocyanate (PPDI); trimethylene, tetramethylene, pentamethylene, hexamethylene, heptamethylene, and/or octamethylene diisocyanate; 2-methylpentamethylene 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophorone diisocyanate, IPDI); 1,4- and/or 1,3-bis(isocyanatomethyl)cyclohexane (HXDI); cyclohexane 1,4-diisocyanate; 1-methylcyclohexane 2,4- and/or 2,6-diisocyanate; dicyclohexylmethane 4,4′-, 2,4′- and/or 2,2′-diisocyanate; octa(aminophenoxy)silsesquioxane (OAPS); 4,4-oxydianiline (ODA); (3-aminopropyl)triethoxysilane (APTES); modified graphene oxides (m-GO); 1,3,5-benzenetricarbonyl trichloride (BTC); poly(maleic anhydride) (PMA); and/or melamine. In some embodiments the polyamide oligomers form a gel without addition of a crosslinker. As illustrative examples, in various embodiments, diacid chlorides that can be used in accordance with aspects of the subject innovation can include, but are not limited to: isophthaloyl chloride (IPC), terephthaloyl chloride (TPC), 2,2-dimethylmalonoyl chloride, 4,4′-biphenyldicarbonyl dichloride, azobenzene-4,4′-dicarbonyl dichloride, 1,4-cyclohexanedicarbonyl dichloride, succinyl chloride, glutaryl chloride, adipoyl chloride, sebacoyl chloride, suberoyl chloride, and/or pimeloyl chloride. Additionally, in various embodiments, illustrative examples of diamines that can be used in accordance with aspects of the subject innovation can include, but are not limited to: 4,4′-oxydianiline (ODA), 2,2′-dimethylbenzidine (DMBZ), 2,2-bis-[4-(4-aminophenoxy)phenyl]propane (BAPP), 3,4′-oxydianiline (3,4-ODA), 4,4′-diaminobiphenyl, methylenedianiline (MDA), 4,4′-(1,4-phenylene-bismethylene)bisaniline (BAX), p-phenylenediamine (pPDA), meta phenylenediamine (mPDA), azodianiline, 1,4-diaminonaphthalene, 1,5-diaminonaphthalene, 1,8-diaminonaphthalene, and/or hexamethylene diamine. In some embodiments, a polyamide aerogel may be made from a suitable polyamide gel using any suitable drying technique, for example, supercritical CO₂ drying, evaporative drying, or freeze drying.

In some embodiments, a polyimide gel suitable for production of a polyimide aerogel is prepared from the reaction of one or more amines with one or more anhydrides. In some embodiments, an amine may be a monoamine, a diamine, or a polyamine. In some embodiments, an anhydride may be a monoanhydride, a dianhydride, or a polyanhydride. In some embodiments, the amine and anhydride react to form a polyamic acid that is then imidized to form a polyimide. In certain embodiments, the polyamic acid is chemically imidized. In some embodiments, the polyamic acid is thermally imidized.

In some embodiments, biphenyl-3,3′,4,4′-tetracarboxylic dianhydride (BPDA), 2,2′-dimethylbenzidine (DMBZ), and 4,4′-oxydianiline (4,4-ODA or ODA), are combined to form anhydride end-capped polyamic acid oligomers wherein the oligomer comprises a repeating unit of the reaction product of BPDA, ODA, and DMBZ, for example, a unit comprising the reaction product of BPDA-ODA-BPDA-DMBZ, and comprises terminal anhydride and/or amine groups, the oligomers having an average degree of polymerization of 10 to 50. In some embodiments, the oligomers are crosslinked via a crosslinking agent, also know as a crosslinker. In some embodiments, the crosslinking agent comprises three or more amine groups. In some embodiments, the crosslinking agent comprises a functional group that reacts with a terminal group on the oligomers to produce a crosslinking-agent-terminated oligomer. In some embodiments, the crosslinking agent comprises functional groups that react with another crosslinking agent molecule to connect crosslinking-agent-terminated oligomers together. In some embodiments, the crosslinking agent is introduced at a balanced stoichiometry of a functional group on the crosslinking agent that is reactive towards a terminal group on the polyimide oligomer to the complementary terminal groups on the polyimide oligomers. In some embodiments, two or more oligomers are attached to the same crosslinking agent. In some embodiments, the resulting network is chemically imidized to yield a porous crosslinked polyimide network. In some embodiments, the oligomers are imidized prior to crosslinking. In some embodiments, the oligomers are imidized concurrently with crosslinking.

In some preferred embodiments, an organic polymer aerogel comprises a three-dimensional network of organic polymer comprising monomers and/or crosslinks of functionality three or greater, e.g., it comprises the reaction product of a crosslinking agent and three or more oligomers and/or the reaction product of a monomer with three or more other monomers. In some preferred embodiments, an organic polymer network comprising trifunctional or higher functionality monomers and/or crosslinking agents provides for an aerogel with suitable strength, stiffness, and toughness properties that when combined with a fibrous batting enables a material with a low shrinkage response upon heating, e.g., exhibits a reduced degree of shrinkage compared to the unreinforced aerogel. As would be understood by those of ordinary skill in the art, the length of a particular dimension of an aerogel or polymer aerogel composite corresponds to the distance between the exterior boundaries of the aerogel or aerogel composite along that dimension. As also would be understood by those of ordinary skill in the art, when measuring three dimensions of an aerogel or aerogel composite, each dimension would be perpendicular to the other two (such that the second dimension would be perpendicular to the first dimension, and the third dimension would be perpendicular to the first and second dimensions). Polyimide aerogels without fibrous batting generally undergo shrinkage when heated. Without wishing to be bound to any particular theory, this may be due to kinetically-trapped configurations of constituent polyimide polymer becoming thermally activated and rearranging into new configurations that achieve favorable pi-pi stacking configurations that serve to bind neighboring polymer chains together, resulting in consolidation of the polymer network and thus the overall aerogel. In some preferred embodiments, a fibrous batting that has been incorporated into the aerogel serves as a microscopic and/or macroscopic scaffold that provides mechanical resistance against consolidation of the aerogel when heated, resulting in less shrinkage compared to the analogous native aerogel that does not contain a fibrous batting. In some preferred embodiments, crosslinked polymer networks comprising trifunctional and/or higher functionality monomers and/or crosslinking agents synergistically interact with a fibrous batting to enable a polymer aerogel composite that exhibits reduced shrinkage upon heating compared with the unreinforced aerogel. In some preferred embodiments, crosslinked polyimide networks comprising trifunctional monomers and/or crosslinking agents synergistically interact with a fibrous batting to enable a polyimide aerogel composite that exhibits reduced shrinkage upon heating compared with the unreinforced aerogel. In some preferred embodiments, crosslinked polymer networks comprising trifunctional and/or higher functionality monomers and/or crosslinking agents exhibit a suitably high compressive modulus that, when combined with a fibrous batting, enables production of a polymer aerogel composite that exhibits a minimal amount of shrinkage upon heating. In some embodiments, the interaction of a crosslinked polyimide network comprising trifunctional and/or higher functionality monomers and/or crosslinking agents that exhibits a high compressive modulus, with a fibrous batting, enables a polymer aerogel composite that exhibits a minimal amount of shrinkage upon heating, e.g., reduced shrinkage upon heating compared with the unreinforced aerogel. In some embodiments, unlike previous aerogel composites containing fibrous battings, such as commercially-available silica aerogel blankets, the combination of high strength, stiffness, and toughness of the organic polymer aerogel network provides for a monolithic aerogel composite that sheds little to no dust when handled and/or heated, exhibits reduced shrinkage upon heating compared to the unreinforced aerogel, and can be machined into arbitrary shapes, whereas silica aerogel composite blankets that comprise silica aerogel and fibrous battings are not monolithic, highly dusty, and not machinable into arbitrary shapes. In some embodiments, organic polymer aerogels that do not contain trifunctional and/or higher functionality monomers and/or crosslinking agents and/or that exhibit a low strength, stiffness, and toughness properties do not result in a polymer aerogel composite that remains monolithic upon handling and/or heating, is substantially dust-free, is machinable, and resists shrinkage upon heating. In some embodiments, indeed, the combination of a polymer network containing trifunctional and/or higher functionality monomers and/or crosslinking agents with a suitably high bulk density, e.g., the polymer network was produced with a suitably high weight percent of polymer during its wet-processing phases, results in a polymer aerogel that has sufficient strength, stiffness, and toughness properties that, when combined with a fibrous batting, results in a polymer aerogel composite that resists shrinkage and remains monolithic when heated. For example, previous works describing synthesis of polyimide aerogels that employ only difunctional monomers, although resulting in a three-dimensional polymer network, result in polyimide aerogels that lack the strength, stiffness, and toughness properties required to produce a polyimide aerogel composite that, when combined with a fibrous batting, resists shrinkage when heated. In certain embodiments, the compressive modulus of the aerogel component is greater than 100 kPa, greater than 500 kPa, greater than 1 MPa, greater than 10 MPa, greater than 50 MPa, greater than 100 MPa; or less than 100 MPa, less than 50 MPa, less than 10 MPa, less than 1 MPa, less than 500 kPa, less than 100 kPa, or less than 50 kPa. Combinations of the above noted ranges, or values outside of these ranges, are possible for the compressive modulus of the polymer aerogel component.

In some embodiments, the polymer aerogel component may exhibit any suitable compressive yield strength. In certain embodiments, the compressive yield strength of the aerogel component is greater than 40 kPa, greater than 100 kPa, greater than 500 kPa, greater than 1 MPa, greater than 5 MPa, greater than 10 MPa, greater than 50 MPa, greater than 100 MPa, or greater than 500 MPa; or less than 500 MPa, less than 100 MPa, less than 50 MPa, less than 10 MPa, less than 5 MPa, less than 1 MPa, less than 500 kPa, less than 100 kPa, or less than 50 kPa. Combinations of the above noted ranges, or values outside of these ranges, are possible for the compressive yield strength of the polymer aerogel component.

In some embodiments, a polyimide gel, from which the polyimide aerogel component of the aerogel composite can be made, is derived from the reaction of one or more amines with one or more anhydrides. In some embodiments, the amine and anhydride react to form a polyamic acid that is then imidized to form a polyimide. In certain embodiments, the polyamic acid is chemically imidized. In some embodiments, the polyamic acid is thermally imidized.

In some preferred embodiments, biphenyl-3,3′,4,4′-tetracarboxylic dianhydride (BPDA), 2,2′-dimethylbenzidine (DMBZ), and 4,4′-oxydianiline (4,4-ODA or ODA), are combined to form anhydride end-capped polyamic acid oligomers wherein the oligomer comprises a repeating unit of order BPDA, ODA, BPDA and DMBZ with terminal anhydride groups, the oligomers having an average degree of polymerization (number or repeat units) of 10 to 50. The oligomers are, in some such embodiments, crosslinked via a crosslinking agent, comprising three or more amine groups, at a balanced stoichiometry of the amine groups to the terminal anhydride groups, and chemically imidized via the addition of acetic anhydride (AA) to yield the porous, highly crosslinked polyimide network

In some embodiments, a polyimide gel is derived from the reaction of one or more anhydrides with one or more isocyanates. In some embodiments, the anhydride comprises a dianhydride. In some embodiments, the isocyanate comprises a diisocyanate, a triisocyanate, tris(isocyanatophenyl)methane, a toluene diisocyanate trimer, and/or methylenediphenyl diisocyanate trimer. In some embodiments, the anhydride and isocyanate are contacted in a suitable solvent.

In some embodiments, the anhydride comprises an aromatic dianhydride; an aromatic trianhydride; an aromatic tetraanhydride; an aromatic anhydride having between 6 and about 24 carbon atoms and between 1 and about 4 aromatic rings which may be fused, coupled by biaryl bonds, or linked by one or more linking groups selected from C1-6 alkylene, oxygen, sulfur, keto, sulfoxide, sulfone and the like; biphenyl-3,3′,4,4′-tetracarboxylic dianhydride (BPDA); 3,3′,4,4′-biphenyl tetracarboxylicdianhydride; 2,3,3′,4′-biphenyl tetracarboxylic acid dianhydride (a-BPDA); 2,2′,3,3′-biphenyl tetracarboxylicdianhydride; 3,3′,4,4′-benzophenone-tetracarboxylic dianhydride; benzophenone-3,3′,4,4′-tetracarboxylic dianhydride (BTDA); pyromelliticdianhydride; 4,4′-hexafluoro isopropylidenebisphthalicdianhydride (6FDA); 4,4′-(4,4′-isopropylidene diphenoxy)-bis(phthalic anhydride); 4,4′-oxydiphthalic anhydride (ODPA); 4,4′-oxydiphthalic dianhydride; 3,3′,4,4′-diphenylsulfonetetracarboxylicdianhydride (DSDA); hydroquinone dianhydride; hydroquinone diphthalic anhydride (HQDEA); 4,4′-bisphenol A dianhydride (BPADA); ethylene glycol bis(trimellitic anhydride) (TMEG); 2,2-bis(3,4-dicarboxyphenyl)propanedianhydride; bis(3,4-dicarboxyphenyl)sulfoxide dianhydride; poly(siloxane-containing dianhydride); 2,3,2′,3′-benzophenone tetracarboxylicdianhydride; 3,3′,4,4′-benzophenone tetracarboxylic dianhydride; naphthalene-2,3,6,7-tetracarboxylic dianhydride; naphthalene-1,4,5,8-tetracarboxylic dianhydride; 3,3′,4,4′-biphenylsulfone tetracarboxylicdianhydride; 3,4,9,10-perylene tetracarboxylicdianhydride; bis(3,4-dicarboxyphenyl)sulfide dianhydride; bis(3,4-dicarboxyphenyl)methane dianhydride; 2,2-bis(3,4-dicarboxyphenyl)propane dianhydride; 2,2-bis(3,4-dicarboxyphenyl)hexafluoropropene; 2,6-dichloro naphthalene 1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; phenanthrene-8,9,10-tetracarboxylic dianhydride; pyrazine-2,3,5,6-tetracarboxylic dianhydride; benzene-1,2,3,4-tetracarboxylic dianhydride; and/or thiophene-2,3,4,5-tetracarboxylic dianhydride.

In some preferred embodiments, the anhydride comprises biphenyl-3,3′,4,4′-tetracarboxylic dianhydride (BPDA).

In some embodiments, the amine comprises 3,4′-oxydianiline (3,4-ODA); 4,4′-oxydianiline (4,4-ODA or ODA); p-phenylene diamine (pPDA); m-phenylene diamine (mPDA); p-phenylene diamine (mPDA); 2,2′-dimethylbenzidine (DMBZ); 4,4′-bis(4-aminophenoxy)biphenyl; 2,2′-bis[4-(4-aminophenoxyl)phenyl]propane; bisaniline-p-xylidene (BAX); 4,4′-methylene dianiline (MDA); 4,4′-[1,3-phenylenebis(1-methyl-ethylidene)]bisaniline (bisaniline-m); 4,4′-[1,4-phenylenebis(1-methyl-ethylidene)]bisaniline (bisaniline-p); 3,3′-dimethyl-4,4′-diaminobiphenyl (o-tolidine); 2,2-bis [4-(4-aminophenoxy)phenyl] propane (BAPP); 3,3′-dihydroxy-4,4′-diamino-biphenyl (HAB); 3,3′-diaminodiphenyl sulfone (3,3′-DDS); 4,4′-diaminodiphenyl sulfone (4,4′-DDS); 4,4′-diaminodiphenyl sulfide (ASD); 2,2-bis [4-(4-aminophenoxy) phenyl] sulfone (BAPS); 2,2-bis[4-(3-aminophenoxy) benzene] (m-BAPS); 1,4-bis(4-aminophenoxy) benzene (TPE-Q); 1,3-bis(4-aminophenoxy) benzene (TPE-R); 1,3′-bis(3-aminophenoxy) benzene (APB-133); 4,4′-bis(4-aminophenoxy) biphenyl (BAPB); 4,4′-diaminobenzanilide (DABA); 9,9′-bis(4-aminophenyl) fluorene (FDA); o-tolidine sulfone (TSN); methelenebis(anthranilic acid) (MBAA); 1,3′-bis(4-aminophenoxy)-2,2-dimethylpropane (DANPG); 2,3,5,6-tetramethyl-1,4-phenylenediamine (TMPD); 3,3′,5,5′-tetramethylbenzidine (3355TMB); 1,5-bis(4-aminophenoxy) pentane (DA5MG); 2,5-diaminobenzotrifluoride (25DBTF); 3,5-diaminobenzotrifluoride (35DBTF); 1,3-diamino-2,4,5,6-tetrafluorobenzene (DTFB); 2,2′-bis(trifluoromethyl)benzidine (22TFMB); 3,3′-bis(trifluoromethyl)benzidine (33TFMB); 2,2-bis[4-(4-aminophenoxy phenyl)]hexafluoropropane (HFBAPP); 2,2-bis(4-aminophenyl)hexafluoropropane (Bis-A-AF); 2,2-bis(3-amino-4-hydroxyphenyl)hexafluoropropane (Bis-AP-AF); 2,2-bis(3-amino-4-methylphenyl)hexafluoropropane (Bis-AT-AF); o-phenylene diamine; diaminobenzanilide; 3,5-diaminobenzoic acid; 3,3′diaminodiphenylsulfone; 4,4′-diaminodiphenylsulfone; 1,3-bis-(4-aminophenoxy)benzene; 1,3-bis(3-aminophenoxy)benzene; 1,4-bis(4aminophenoxy)benzene; 1,4-bis(3-aminophenoxy)benzene; 2,2-bis[4-(4-aminophenoxy)phenyl]hexafluoropropane; 2,2-bis(3-aminophenyl)hexafluoropropane; 4,4′-isopropylidenedianiline; 1-(4-aminophenoxy)-3-(3-aminophenoxy)benzene; 1-(4-aminophenoxy)-4-(3-aminophenoxy)benzene; bis[4-(4aminophenoxy)phenyl]sulfone; bis[4-(3-aminophenoxy)phenyl]sulfone; bis(4-[4-aminophenoxy]phenyl)ether; 2,2′-bis(4-aminophenyl)hexafluoropropene; 2,2′-bis(4-phenoxyaniline)isopropylidene; 1,2-diaminobenzene; 4,4′-diaminodiphenylmethane; 2,2-bis(4-aminophenyl)propane; 4,4′-diaminodiphenylpropane; 4,4′-diaminodiphenylsulfide; 4,4-diaminodiphenylsulfone; 3,4′-diaminodiphenylether; 4,4′-diaminodiphenylether; 2,6-diaminopyridine; bis(3-aminophenyl)diethylsilane; 4,4′-diaminodiphenyldiethylsilane; benzidine-3′-dichlorobenzidine; 3,3′-dimethoxybenzidine; 4,4′-diaminobenzophenone; N,N-bis(4-aminophenyl)butylamine; N,N-bis(4-aminophenyl)methylamine; 1,5-diaminonaphthalene; 3,3′-dimethyl-4,4′-diaminobiphenyl; 4-aminophenyl-3-aminobenzoate; N,N-bis(4-aminophenyl)aniline; bis(p-beta-amino tert-butyl phenyl)ether; p-bis-2-(2-methyl-4-aminopentyl)benzene; p-bis(1,1-dimethyl-5-aminopentyl)benzene; 1,3-bis(4-aminophenoxy)benzene; m-xylene diamine; p-xylene diamine; 4,4′-diamino diphenylether phosphine oxide; 4,4′-diamino diphenyl N-methylamine; 4,4′-diamino diphenyl N-phenylamine; amino-terminal polydimethylsiloxanes; amino-terminal polypropylene oxides; amino-terminal polybutylene oxides; 4,4′-methylene bis(2-methyl cyclohexylamine); 1,2-diaminoethane; 1,3-diaminopropane; 1,4-diaminobutane; 1,5-diaminopentane; 1,6-diaminohexane; 1,7-diaminoheptane; 1,8-diaminooctane; 1,9-diaminononane; 1,10-diaminodecane; 4,4′-methylene bis(benzeneamine); 2,2′-dimethyl benzidine; bisaniline-p-xylidene; 4,4′-bis(4-aminophenoxy)biphenyl; 3,3′-bis(4-aminophenoxy)biphenyl; 4,4′-(1,4-phenylene diisopropylidene)bisaniline; and/or 4,4′-(1,3-phenylene diisopropylidene)bisaniline,

In some preferred embodiments, the amine comprises 4,4′-oxydianiline (4,4-ODA or ODA), 2,2′-dimethylbenzidine (DMBZ), and/or 4,4′-[1,3-phenylenebis(1-methyl-ethylidene)]bisaniline (bisaniline-m).

In some embodiments, the isocyanate comprises a triisocyanate; an aliphatic triisocyanate; an aromatic isocyanate comprising three or more isocyanate groups; an aromatic triisocyanate; a triisocyanate based on hexamethylene diisocyanate; the trimer of hexamethylenediisocyanate; hexamethylenediisocyanate; a triisocyanate comprising isocyanurate; a diisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodurblulogiq 3190; Desmodur XP 2860; Desmodur N3400; Desmodur XP 2840; Desmodur N3580 BA; Desmodur N3500; Desmodur RE; tris(isocyanatophenyl)methane; Desmodur RC; Mondur® MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/or p-phenylenediisocyanate (PPDI); trimethylene, tetramethylene, pentamethylene, hexamethylene, heptamethylene and/or octamethylenediisocyanate; 2-methylpentamethylene 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophoronediisocyanate, IPDI); 1,4- and/or 1,3-bis(isocyanatomethyl)cyclohexane (HXDI); cyclohexane 1,4-diisocyanate; 1-methylcyclohexane 2,4-diisocyanate; 1-methylcyclohexane 2,6-diisocyanate; dicyclohexylmethane 4,4′-diisocyanate; dicyclohexylmethane 2,4′-diisocyanate; and/or dicyclohexylmethane 2,2′-diisocyanate.

In some embodiments, a polyimide gel is derived from the reaction of an amine with an anhydride. In some embodiments, the reaction of amine and anhydride forms poly(amic acid) oligomers. In some embodiments the poly(amic acid) oligomers are chemically imidized to yield polyimide oligomers. In some embodiments chemical imidization is achieved by contacting the poly(amic acid) oligomer with a dehydrating agent. In some embodiments the dehydrating agent comprises acetic anhydride, propionic anhydride, n-butyric anhydride, benzoic anhydride, trifluoroacetic anhydride, phosphorous trichloride, and/or dicyclohexylcarbodiimide. In some embodiments chemical imidization is catalyzed by contacting the solution comprised of poly(amic acid) oligomers and dehydrating agent(s) with an imidization catalyst.

In some embodiments the imidization catalyst comprises pyridine; a methylpyridine; quinoline; osoquinoline; 1,8-diazabicyclo[5.4.0]undec-7-ene (DBU); DBU phenol salts; carboxylic acid salts of DBU; triethylenediamine; a carboxylic acid salt of triethylenediamine; lutidine; n-methylmorpholine; triethylamine; tripropylamine; tributylamine; N,N-dimethylbenzylamine; N,N′-dimethylpiperazine; N,N-dimethylcyclohexylamine; N,N′,N″-tris(dialkylaminoalkyl)-s-hexahydrotriazines, for example N,N′,N″-tris(dimethylaminopropyI)-s-hexahydrotriazine; tris(dimethylaminomethyl)phenol; bis(2-dimethylaminoethyl) ether; N,N,N,N,N-pentamethyldiethylenetriamine; methylimidazole; dimethylimidazole; dimethylbenzylamine; 1,6-diazabicyclo[5.4.0]undec-7-ene (IUPAC: 1,4-diazabicyclo[2.2.2]octane); triethylenediamine; dimethylaminoethanolamine; dimethylaminopropylamine; N,N-dimethylaminoethoxyethanol; N,N,N-trimethylaminoethylethanolamine; triethanolamine; diethanolamine; triisopropanolamine; diisopropanolamine; and/or any suitable trialkylamine.

In some embodiments, a polyimide gel is derived from the reaction of an amine with an anhydride. In some embodiments, the reaction of amine and anhydride forms poly(amic acid) oligomers. In some embodiments the poly(amic acid) oligomers are thermally imidized to yield polyimide oligomers. In some embodiments, the poly(amic acid) oligomers are heated to a temperature of greater than about 80° C., greater than about 90° C., greater than about 100° C., greater than about 150° C., greater than about 180° C., greater than about 190° C., or any suitable temperature.

In some embodiments, the diamine and/or dianhydride may be selected based on commercial availability and/or price. In some embodiments, the diamine and/or dianhydride may be selected based on desired material properties. In some embodiments, a specific diamine and/or dianhydride may impart specific properties to the polymer. For example, in some embodiments, diamines and/or dianhydrides with flexible linking groups between phenyl groups can be used to make polyimide aerogels with increased flexibility. In some embodiments, diamines and/or dianhydrides comprising pendant methyl groups can be used to make polyimide aerogels with increased hydrophobicity. In other embodiments, diamines and/or dianhydrides comprising fluorinated moieties such as trifluoromethyl can be used to make polyimide aerogels with increased hydrophobicity.

In some embodiments, two or more diamines and/or two or more dianhydrides are used. In an illustrative embodiment, two diamines are used. The mole percent of the first diamine relative to the total of the two diamines can be varied from about 0% to about 100%. The mole percent of the first diamine relative to the total of the two diamines comprises, in some embodiments, less than about 99.9%, less than about 90%, less than about 80%, less than about 70%, less than about 60%, less than about 50%, less than about 40%, less than about 30%, less than about 20%, less than about 10%, less than about 0.1%, or less. In further embodiments, wherein more than two diamines are used, the mole percent of each diamine relative to the total diamines can be varied from about 0.1% to about 99.9%. In a further illustrative example, two dianhydrides are used. The mole percent of the first dianhydride relative to the total of the two dianhydride can be varied from about 0.1% to about 99.9%. In some embodiments, the mole percent of the first dianhydride relative to the total of the two dianhydrides comprises less than about 99.9%, less than about 90%, less than about 80%, less than about 70%, less than about 60%, less than about 50%, less than about 40%, less than about 30%, less than about 20%, less than about 10%, less than about 0.1%, or less. In further embodiments, wherein more than two dianhydrides are used, the mole percent of each dianhydride relative to the total dianhydride can be varied from about 0.1% to about 99.9%.

In some embodiments, multiple diamines are used. In some embodiments, the first diamine is added to the solvent, after which the dianhydride is then added. In some embodiments, each amino site on the diamine reacts with an anhydride site on different dianhydrides, such that anhydride-terminated oligomers are formed. In some embodiments, a second diamine is then added to the solution. These diamines react with terminal anhydrides on the oligomers in solution, forming longer amino-terminated oligomers. Oligomers of varying lengths result from such a process, and that an alternating motif of first diamine, then dianhydride, then second diamine, results. Without wishing to be bound by any particular theory, it is believed that this approach encourages spatial homogeneity of properties throughout the gel network, where simply mixing all monomers together simultaneously and allowing dianhydrides and diamines to react with other simultaneously at random may lead to phase segregation of domains rich in one particular diamine and/or spatial heterogeneity.

In some embodiments, the weight percent polymer in solution is controlled during polyimide gel synthesis. The term weight percent polymer in solution refers to the weight of monomers in solution minus the weight of byproducts resulting from condensation reactions among the monomers, relative to the weight of the solution. The weight percent polymer in solution can be less than about 1%, less than about 2%, less than about 3%, less than about 4%, less than about 5%, less than about 6%, less than about 7%, less than about 8%, less than about 9%, less than about 10%, less than about 12%, less than about 14%, less than about 16%, less than about 18%, less than about 20%, and/or between 20% and 30%. In some preferred embodiments, the weight percent polymer is between 5% and 15%.

In some embodiments, the reaction of diamine and dianhydride produces an oligomer comprising a repeating unit of at least a diamine and a dianhydride. In some embodiments, the oligomer comprises about 1 repeat unit, less than about 2 repeat units, less than about 5 repeat units, less than about 10 repeat units, less than about 20 repeat units, less than about 30 repeat units, less than about 40 repeat units, less than about 50 repeat units, less than about 60 repeat units, less than about 80 repeat units, less than about 100 repeat units, or less than about 200 repeat units. In some embodiments, the oligomer has an average degree of polymerization of less than about 10, less than about 20, less than about 30, less than about 40, less than about 60, less than about 80, or less than about 100. In some embodiments, the oligomer comprises terminal anhydride groups, i.e., both ends of the oligomer comprise a terminal anhydride group. In some embodiments, the oligomer comprises terminal amine groups, i.e., both ends of the oligomer comprise a terminal amine group.

In some embodiments, the oligomers are crosslinked by a crosslinking agent. In some embodiments, the terminal end group on the oligomer reacts with a polyfunctional crosslinking agent, which then reacts with the terminal end group on at least one other oligomer. In some embodiments, the crosslinking agent comprises a triamine; an aliphatic triamine; an aromatic amine comprising three or more amine groups; an aromatic triamine; 1,3,5-tris(aminophenoxy)benzene (TAB); tris(4-aminophenyl)methane (TAPM); tris(4-aminophenyl)benzene (TAPB); tris(4-aminophenyl)amine (TAPA); 2,4,6-tris(4-aminophenyl)pyridine (TAPP); 4,4′,4″-methanetriyltrianiline; N,N,N′,N′-tetrakis(4-aminophenyl)-1,4-phenylenediamine; a polyoxypropylenetriamine; N′,N′-bis(4-aminophenyl)benzene-1,4-diamine; a triisocyanate; an aliphatic triisocyanate; an aromatic isocyanate comprising three or more isocyanate groups; an aromatic triisocyanate; a triisocyanate based on hexamethylene diisocyanate; the trimer of hexamethylenediisocyanate; hexamethylenediisocyanate; a polyisocyanate; a polyisocyanate comprising isocyanurate; Desmodur® N3200; Desmodur N3300; Desmodur N100; Desmodur N3400; Desmodur N3390; Desmodur N3390 BA/SN; Desmodur N3300 BA; Desmodur N3600; Desmodur N3790 BA; Desmodur N3800; Desmodur N3900; Desmodur XP 2675; Desmodurblulogiq 3190; Desmodur XP 2860; Desmodur N3400; Desmodur XP 2840; Desmodur N3580 BA; Desmodur N3500; Desmodur RE; tris(isocyanatophenyl)methane; Desmodur RC; Mondur® MR; Mondur MRS; a methylene diphenyl diisocyanate; diphenylmethane 2,2′-, 2,4′- and/or 4,4′-diisocyanate (MDI); naphthylene 1,5-diisocyanate (NDI); a toluene diisocyanate; toluene 2,4- and/or 2,6-diisocyanate (TDI); 3,3′-dimethylbiphenyl diisocyanate; 1,2-diphenylethane diisocyanate and/orp-phenylenediisocyanate (PPDI); trimethylene, tetramethylene, pentamethylene, hexamethylene, heptamethylene, and/or octamethylenediisocyanate; 2-methylpentamethylene 1,5-diisocyanate; 2-ethylbutylene 1,4-diisocyanate; pentamethylene 1,5-diisocyanate; butylene 1,4-diisocyanate; 1-isocyanato-3,3,5-trimethyl-5-isocyanatomethylcyclohexane (isophoronediisocyanate, IPDI); 1,4- and/or 1,3-bis(isocyanatomethyl)cyclohexane (HXDI); cyclohexane 1,4-diisocyanate; 1-methylcyclohexane 2,4- and/or 2,6-diisocyanate; dicyclohexylmethane 4,4′-, 2,4′- and/or 2,2′-diisocyanate; octa(aminophenoxy)silsesquioxane (OAPS); 4,4-oxydianiline (ODA); (3-aminopropyl)triethoxysilane (APTES); modified graphene oxides (m-GO); 1,3,5-benzenetricarbonyl trichloride (BTC); poly(maleic anhydride) (PMA); an imidazole or a substituted imidazole; a triazole or substituted triazole; a purine or substituted purine; a pyrazole or substituted pyrazole; and/or melamine.

In some embodiments, the reaction between amine and anhydride, and/or the chemical imidization, takes place in a solvent. In some embodiments, the solvent comprises dimethylsulfoxide; diethylsulfoxide; N,N-dimethylformamide; N,N-diethylformamide; N,N-dimethylacetamide; N,N-diethylacetamide; N-methyl-2-pyrrolidone; 1-methyl-2-pyrrolidinone; N-cyclohexyl-2-imidazolidinone; diethylene glycol dimethoxyether; o-dichlorobenzene; phenols; cresols; xylenol; catechol; butyrolactones; and/or hexamethylphosphoramides.

In some embodiments, a polyimide aerogel may be made from a suitable polyimide gel using any suitable drying technique, for example, supercritical CO₂ drying, evaporative drying, or freeze drying.

Polyimide aerogels that exhibit good mechanical strength and durability (such as Airloy® X116-L polyimide aerogel manufactured by Aerogel Technologies, LLC, Boston, USA) are potentially interesting materials for use in applications that involve lightweight structural or semi-structural elements exposed to elevated temperatures (e.g., temperatures up to about 300° C., about 350° C., about 400° C., or higher). Airloy X116-L is one such a polyimide aerogel which comprises an engineered microstructure comprising a reaction product of biphenyl tetracarboxylic dianhydride, dimethylbenzidine, and oxydianiline that provides high mechanical strength, stiffness, and toughness at a low density while simultaneously offering a low thermal conductivity thanks in part to its highly porous mesoporous geometry.

One particular application area of interest is high-performance engine cover materials. In fuel-powered automobiles, engine covers are shaped covers used on top of the engine, inside the engine compartment. The engine cover serves to thermally insulate the engine, ensuring it remains at its operating temperature to operate efficiently and protects other components inside the engine compartment as well as the hood of the car from the high temperatures generated by the engine. In addition, the engine cover serves to improve passenger comfort in the vehicle by reducing the noise and vibrations, and from reaching the passenger cabin. Between the engine cover and the engine a second material designed to reduce noise, vibration, and harshness (NVH) is typically provided, typically called an NVH pad. The next generations of fuel-efficient vehicles will increasingly utilize hotter engines to achieve higher fuel economy inside ever shrinking engine compartments as vehicle sizes are reduced to reduce weight. This requires engine covers capable of withstanding such higher engine temperatures that can provide the necessary thermal insulating functions in a low profile with minimal added weight. Materials that simultaneously offer high sound transmission loss properties are also advantageous as they can provide NVH functions without the need for additional weight and cost.

In addition to thermal and acoustic properties, engine cover materials must also exhibit ancillary properties required for practical use in automotive applications. The material should generally be mechanically robust, for example, to withstand handling by automotive technicians; should exhibit good thermomechanical stability, that is, that it does not shrink or decompose at the temperatures required by the application (ideally in excess of 200° C. or higher); is preferably non-flammable for safety reasons; is lightweight to reduce fuel consumption; can be shaped to fit the engine and surrounding components; and can achieve all of these functions in a low profile, that is, with as little thickness as possible. Finally, it is desirable for the material to be generally easy to manufacture and as cost-efficient as possible.

There are several types of materials currently in use for engine covers today. One common configuration involves use of a glass-fiber-filled Nylon hard shell for the engine cover to provide the structural properties required for the engine cover accompanied by a fiber batting material mechanically attached to its underside used to provide thermal insulation and NVH reduction.

A newer engine cover design preferred by automotive manufacturers is made from injection-molded polyurethane foams. Such foams are typically soft and semi-flexible and provide thermal insulation and NVH reduction functions while simultaneously being mechanically robust enough to be suitable in the engine cover application. A typical such material used for engine covers today exhibits a bulk density around 0.145 g/cc and a thermal conductivity at room temperature is 45 mW/m-K. Such materials are generally limited to 130° C. operating temperatures, although may be capable of temporarily withstanding temperatures of 200° C. to 225° C., and are extremely flammable, propagating flame, releasing toxic smoke and fumes, and dripping melted polyurethane when ignited. For future configurations, however, engine covers will need to be made of materials capable of regularly withstanding operating temperatures in excess of 200° C. or even hotter in an even thinner form factor, necessitating a shift from polyurethane foam to a superior structural insulation material.

Polyimide aerogels such Airloy X116-L can potentially meet many of the materials properties needs for use as next-generation engine covers. For example Airloy X116-L polyimide aerogel exhibits low thermal conductivity (in the range of 23-26 mW/m-K) while simultaneously being chemically stable to temperatures over 300° C., is non-flammable, and exhibits a low bulk density (in the range of 0.09-0.13 g/cc). Airloy X116-L polyimide aerogel is also mechanically durable and can be shaped easily by molding during its wet-gel precursor phase or subtractive machining after drying. There are some materials properties aspects of this and other such polyimide aerogels that would need to be improved in order for them to be suitable for use in commercial engine cover applications, however. While the polyimide polymer that the aerogel comprises may be chemically stable to temperatures of 300° C.−400° C., polyimide aerogels typically shrink when annealed at temperatures above about 100° C., undergoing a one-time dimensional shrinkage linearly proportional to the annealing temperature. This decrease in dimension corresponds with an increase in material density due to consolidation of the underlying porous network leading to degraded thermal and acoustic insulative performance. Furthermore, if not annealed correctly i.e. uniformly and slowly, such dimensional changes may also lead to some degree of nonuniform part deformation, resulting in a warped aerogel part.

Additionally, while polyimide aerogels such as Airloy X116-L can be quite mechanically strong and substantially stronger and more fracture tough compared to other aerogels such as silica aerogels, polyimide aerogels may not natively possess the fracture toughness and durability required for use in an automotive environment. During vehicle maintenance, for example, the engine cover may be subjected to impacts and high forces due to handling by a technician, dropped tools, or aggressive handling during removal and installation, and accordingly the cover must not be easily broken during these operations.

In accordance with certain embodiments, a method for improving the strength, stiffness, fracture toughness, and/or dimensional stability at elevated temperatures of a polymer aerogel material is described herein along with specific polymer aerogel composite materials that exhibit improved strength, stiffness, fracture toughness, and/or dimensional stability at elevated temperatures over native polymer aerogels. This method involves, in some embodiments, incorporating additives or other composite materials into the aerogel in order to improve performance in these areas. In some embodiments, this method may involve incorporating a lofty fibrous batting into a polymer aerogel.

While in principle a composite of a polymer aerogel with other materials can be made subsequent to the production of the polymer aerogel to address the above-mentioned property shortcomings of native polymer aerogels, doing so involves additional manufacturing steps and may add additional cost to manufacture. The present disclosure describes certain embodiments that, instead, involve incorporating compositing solid-phase additives such as discrete fibers and/or fibrous battings into the liquid-phase sol prior to gelation and then subsequently drying the resulting additive-containing gel to produce a polymer aerogel composite. Thus the compositing step is incorporated into the normal sol-gel process without additional post-processing steps being required.

In some embodiments, compositing materials may include a thickening agent, a conventional plastics-reinforcing additive, and/or a felt, i.e., a fibrous batting. Those of ordinary skill in the art are familiar with fibrous battings, which are fiber-containing materials in which the fibers interact with each other to produce inter-fiber structural reinforcement in at least two (and sometimes three) dimensions. A collection of fibers that do not interact with each other to produce inter-fiber structural reinforcement does not constitute a fibrous batting. In some preferred embodiments, the fibrous batting comprises a polyaramid, e.g., poly-paraphenylene terephthalamide (e.g., Kevlar*brand), poly-metaphenylene isophthalamide (e.g., Nomex© brand); a carbon, e.g., carbon fiber, ex-PAN carbon fiber, graphite fiber; a silica, e.g., glass, E-glass, S-glass, amorphous silica, quartz; a mineral wool; a polyester, e.g., polyester terephthalate; a biopolymer, e.g., cotton, cellulose; a polyamide (e.g., Nylon® brand); a nanotube, e.g., carbon nanotubes, boron nitride nanotubes; a ceramic, e.g., an oxide, a nitride, a carbide, a silicides; an aerogel fiber, i.e., a fiber itself comprising aerogel; a polyethylene; a polypropylene; a polyalkylene; or any other suitable fibrous batting. In some embodiments, additives may include chopped glass fiber (e.g., ¼″ chopped glass fiber), milled glass fiber (e.g., 1/16″ milled glass fiber), thixotropic silica, poly-paraphenylene terephthalamide (e.g., Kevlar brand) pulp, chopped graphite fiber (e.g., ¼″ chopped graphite fiber), and/or carbon felt (e.g., 0.07 g/cc). In some embodiments, ¼″ chopped glass fiber, 1/16″ milled glass fiber, and/or thixotropic silica may not disperse well in the sol. In some preferred embodiments, poly-paraphenylene terephthalamide pulp and/or graphite fiber disperse well in the sol and may act to substantially thicken, i.e., increase the viscosity of, the sol. In some embodiments, poly-paraphenylene terephthalamide pulp may be added to the sol at two different predefined loadings, a so-called high loading of 2.31 g pulp per 100 g sol or a so-called low loading of 0.42 g pulp per 100 g of sol. Other loadings may be used as well. In some embodiments, graphite fiber may be added to the sol at two different predefined loadings, a so-called high loading of 6.15 g pulp per 100 g sol or a so-called low loading of 2.00 g pulp per 100 g of sol. Other loadings may be used as well. In some embodiments, the predefined low loading for a fiber additive may be based on the manufacturer recommended addition fraction for standard plastics reinforcement for said additive, while the high loading may be based a level of several times greater than this. In some embodiments, a sol is added, e.g., poured, into a fibrous batting, e.g., a felt. In some embodiments, a fibrous batting is placed into a pool of sol.

In some preferred embodiments, a sol is readily uptaken into the felt. In some embodiments, when added to a carbon felt, the sol easily infiltrated. In some embodiments, when added to a carbon felt, the sol easily infiltrates the felt. In some embodiments, when added to a polyaramid batting, the sol easily infiltrates the felt. In some embodiments, when added to a polyester batting, the sol easily infiltrates the felt. In some embodiments, when added to a glass fiber batting, the sol easily infiltrates the felt.

In some embodiments, the gel composites are solvent exchanged into an organic solvent, i.e., the pore liquor within the gels is substantially replaced by the organic solvent through diffusive soaking in a bath of the target organic solvent, and then subsequently dried via any suitable method for making an aerogel. In some embodiments, the gel composites are solvent exchanged into acetone, and then subsequently dried via any suitable method for making an aerogel. In some embodiments, the drying method comprises subcritical CO₂ evaporative drying, supercritical drying from CO₂, supercritical drying from organic solvent, ambient-pressure evaporation of solvent from gel, and/or freeze drying of the gel. In some embodiments, the dried polymer aerogel composites containing compositing additives are qualitatively substantially stronger than their native aerogel-only analogs. In some embodiments, higher loadings of additives result in polymer aerogel composites with a higher modulus and strength than lower loadings. In some embodiments, polymer aerogel composites containing dispersed graphite fibers may not exhibit a fully homogenous distribution of fibers which may be evidenced by non-uniform distribution of color of the composite (black and yellow regions). In some embodiments, poly-paraphenylene terephthalamide pulp may be evenly distributed in the polymer aerogel composite, but at high loading may thicken the precursor sol so much that air pockets may be created in the gel upon mixing. In some embodiments, polymer aerogel composites containing carbon felt may appear macroscopically homogenous within the felt, while in some embodiments some excess aerogel material may be present on the outside of the surfaces of the composite.

In certain embodiments, a composite comprising an aerogel and a fibrous batting exhibits little or no change in at least one dimension (or at least two orthogonal dimensions, or all dimensions) after being heated (e.g., to a temperature of 200° C.). The ability of the composite to resist heat-induced dimensional change (e.g., warping) can make it suitable for long-term use in many mechanical applications (e.g., as an engine cover).

In some embodiments, when a sample of the aerogel composite with dimensions of 6.5 cm×2.0 cm×0.5 cm and/or the aerogel composite itself, initially at a temperature of 25° C., is transferred from an environment at 25° C. and 1 atm pressure of air into an evenly-heated oven at a temperature of 200° C. and 1 atm pressure of air and is left in the oven for a period of 60 min, a length of at least one dimension (or at least two orthogonal dimensions, or all dimensions) of the sample or the aerogel composite does not shrink or shrinks by less than 10% (or less than 5%, or less than 2%, or less than 1%) relative to its length prior to the heating. As would be understood by those of ordinary skill in the art, when the aerogel composite is larger than 6.5 cm×2.0 cm×0.5 cm, the sample would be obtained by cutting away portions of the aerogel composite until a 6.5 cm×2.0 cm×0.5 cm portion remains. For aerogel composites smaller than 6.5 cm×2.0 cm×0.5 cm, the aerogel composite itself would serve as the sample. To perform this test on an aerogel composite material, one would allow the material being tested (i.e., the sample or the aerogel composite itself) to reach 25° C. evenly throughout its volume, within an air environment at 25° C. and 1 atm pressure. One would then transfer the material being tested from the environment at 25° C. and 1 atm pressure to an oven that has been evenly pre-heated to a temperature of 200° C. at 1 atm pressure. One would then leave the material being tested in the oven for 60 minutes, remove the material from the oven, and allow the material to return to 25° C. One would then measure the dimensions of the material and compare those dimensions to the dimensions of the material prior to the heating step.

In some embodiments, the aerogel composite is larger than or equal to 6.5 cm×2.0 cm×0.5 cm, and when a sample of the aerogel composite with dimensions of 6.5 cm×2.0 cm×0.5 cm, initially at a temperature of 25° C., is transferred from an environment at 25° C. and 1 atm pressure into an evenly-heated oven at a temperature of 200° C. and 1 atm pressure and is left in the oven for a period of 60 min, a length of at least one dimension (or at least two orthogonal dimensions, or all dimensions) of the sample does not shrink or shrinks by less than 10% (or less than 5%, or less than 2%, or less than 1%) relative to its length prior to the heating.

In some embodiments, the aerogel composite is smaller than 6.5 cm×2.0 cm×0.5 cm, and when the aerogel composite, initially at a temperature of 25° C., is transferred from an environment at 25° C. and 1 atm pressure into an evenly-heated oven at a temperature of 200° C. and 1 atm pressure and is left in the oven for a period of 60 min, a length of at least one dimension (or at least two orthogonal dimensions, or all dimensions) of the aerogel composite does not shrink or shrinks by less than 10% (or less than 5%, or less than 2%, or less than 1%) relative to its length prior to the heating.

In some embodiments, when the aerogel composite (having any dimensions), initially at a temperature of 25° C., is transferred from an environment at 25° C. and 1 atm pressure into an evenly-heated oven at a temperature of 200° C. and 1 atm pressure and is left in the oven for a period of 60 min, a length of at least one dimension (or at least two orthogonal dimensions, or all dimensions) of the aerogel composite does not shrink or shrinks by less than 10% (or less than 5%, or less than 2%, or less than 1%) relative to its length prior to the heating.

In some embodiments, the aerogel composite is larger than or equal to 6.5 cm×2.0 cm×0.5 cm, and when a sample of the aerogel composite with dimensions of 6.5 cm×2.0 cm×0.5 cm, initially at a temperature of 25° C., is transferred from an environment at 25° C. and 1 atm pressure into an evenly-heated oven at a temperature of 200° C. and 1 atm pressure and is left in the oven for a period of 60 min, a length of at least one dimension (or at least two orthogonal dimensions, or all dimensions) of the sample does not expand or expands by less than 10% (or less than 5%, or less than 2%, or less than 1%) relative to its length prior to the heating.

In some embodiments, the aerogel composite is smaller than 6.5 cm×2.0 cm×0.5 cm, and when the aerogel composite, initially at a temperature of 25° C., is transferred from an environment at 25° C. and 1 atm pressure into an evenly-heated oven at a temperature of 200° C. and 1 atm pressure and is left in the oven for a period of 60 min, a length of at least one dimension (or at least two orthogonal dimensions, or all dimensions) of the aerogel composite does not expand or expands by less than 10% (or less than 5%, or less than 2%, or less than 1%) relative to its length prior to the heating.

In some embodiments, when the aerogel composite (having any dimensions), initially at a temperature of 25° C., is transferred from an environment at 25° C. and 1 atm pressure into an evenly-heated oven at a temperature of 200° C. and 1 atm pressure and is left in the oven for a period of 60 min, a length of at least one dimension (or at least two orthogonal dimensions, or all dimensions) of the aerogel composite does not expand or expands by less than 10% (or less than 5%, or less than 2%, or less than 1%) relative to its length prior to the heating.

In some embodiments, an aerogel and/or aerogel composite may exhibit an internal specific surface area. In some embodiments, the internal specific surface area of an aerogel and/or aerogel composite may be determined using nitrogen adsorption porosimetry and deriving the surface area value using the Brunauer-Emmett-Teller (BET) model. For example, nitrogen sorption porosimetry may be performed using a Micromeritics Tristar II 3020 surface area and porosity analyzer. Before porosimetry analysis, specimens may be subjected to vacuum of ˜100 torr for 24 hours to remove adsorbed water or other solvents from the pores of the specimens. The porosimeter may provide an adsorption isotherm and desorption isotherm, which comprise the amount of analyte gas adsorbed or desorbed as a function of partial pressure. Specific surface area may be calculated from the adsorption isotherm using the BET method over ranges typically employed in measuring surface area. In some embodiments, the internal surface area of the aerogel composite is greater than about 50 m²/g, greater than about 100 m²/g, greater than about 200 m²/g, greater than about 300 m²/g, greater than about 400 m²/g, greater than about 500 m²/g, greater than about 600 m²/g, greater than about 700 m²/g, greater than about 800 m²/g, greater than about 1000 m²/g, greater than about 2000 m²/g, greater than about 3000 m²/g, less than about 4000 m²/g. In certain preferred embodiments, the internal surface area of the aerogel is between about 50 m²/g and about 800 m²/g. Values of the internal surface area of the aerogel outside of these ranges may be possible.

In some embodiments, the bulk density of an aerogel and/or aerogel composite may be determined by dimensional analysis. For example, bulk density may be measured by first carefully machining a specimen into a regular shape, e.g., a block or a rod. The length, width, and thickness (or length and diameter) may be measured using calipers (accuracy±0.001″). These measurements may then be used to calculate the specimen volume by, in the case of a block, multiplying length*width*height, or in the case of a disc, multiplying the length*the radius squared*pi. Mass may be measured using a digital analytical balance with a precision of 0.001 g. Bulk density may then be calculated as density=mass/volume.

In some embodiments, the bulk density of the polymer aerogel composite may be between about 0.05 g/cc and about 0.1 g/cc, between about 0.05 g/cc and about 0.2 g/cc, between about 0.05 g/cc and about 0.3 g/cc, between about 0.05 and about 0.4 g/cc, between about 0.05 g/cc and about 0.5 g/cc, between about 0.05 g/cc and about 0.6 g/cc, between about 0.05 g/cc and about 0.7 g/cc, or greater than 0.7 g/cc. In certain embodiments, the density may be between about 0.15 g/cc and 0.7 g/cc. In certain preferred embodiments, the density may be between about 0.09 g/cc and 0.25 g/cc.

In some embodiments, an aerogel and/or aerogel composite has at least one dimension that is greater than about 10 cm, greater than about 50 cm, and/or greater than about 100 cm.

In some embodiments, an aerogel and/or aerogel composite has at least two dimensions that are greater than about 10 cm, greater than about 50 cm, and/or greater than about 100 cm.

In some embodiments, an aerogel and/or aerogel composite has three dimension that are greater than about 10 cm, greater than about 50 cm, and/or greater than about 100 cm.

In some embodiments, an aerogel and/or aerogel composite has a flexural modulus and flexural yield strength which may be determined using a standard mechanical testing method. Flexural modulus and yield strength may be measured using the method outlined in ASTM D790-10 “Flexural Properties of Unreinforced and Reinforced Plastics and Electrical Insulating Materials” followed as written, with the exception that specimen span was equal to a fixed value of 45.28 mm rather than varied as a ratio of the thickness of the specimen. Specimen length used was typically at least 10 mm greater than the span. Specimen depth was typically in the range of 5 mm to 7 mm. Specimen width was typically in the range of 15 mm to 20 mm. In certain embodiments, the flexural modulus of the polymer aerogel composite, as measured by the described method, may between about 10 MPa and about 20 MPa, between about 20 MPa and about 50 MPa, between about 50 MPa and about 100 MPa, between about 100 MPa and about 200 MPa, between about 200 MPa and about 300 MPa, or greater than about 300 MPa.

In some embodiments, an aerogel and/or aerogel composite has a compressive modulus (also known as Young's modulus, in some embodiments approximately equal to bulk modulus) and yield strength which may be determined using standard uniaxial compression testing. Compressive modulus and yield strength may be measured using the method outlined in ASTM D1621-10 “Standard Test Method for Compressive Properties of Rigid Cellular Plastics” followed as written with the exception that specimens are compressed with a crosshead displacement rate of 1.3 mm/s (as prescribed in ASTM D695) rather than 2.5 mm/s.

In some embodiments, the polymer aerogel composite may exhibit any suitable compressive modulus. In certain embodiments, the compressive modulus of the aerogel composite is greater than 100 kPa, greater than 500 kPa, greater than 1 MPa, greater than 10 MPa, greater than 50 MPa, greater than 100 MPa; or less than 100 MPa, less than 50 MPa, less than 10 MPa, less than 1 MPa, less than 500 kPa, less than 100 kPa, or less than 50 kPa. Combinations of the above noted ranges, or values outside of these ranges, are possible for the compressive modulus of the polymer aerogel composite.

In some embodiments, the polymer aerogel composite may exhibit any suitable compressive yield strength. In certain embodiments, the compressive yield strength of the aerogel composite is greater than 40 kPa, greater than 100 kPa, greater than 500 kPa, greater than 1 MPa, greater than 5 MPa, greater than 10 MPa, greater than 50 MPa, greater than 100 MPa, greater than 500 MPa; or less than 500 MPa, less than 100 MPa, less than 50 MPa, less than 10 MPa, less than 5 MPa, less than 1 MPa, less than 500 kPa, less than 100 kPa, or less than 50 kPa. Combinations of the above noted ranges, or values outside of these ranges, are possible for the compressive yield strength of the polymer aerogel composite.

In some embodiments, the polymer aerogel composite may exhibit any suitable compressive ultimate strength. In certain embodiments, the compressive ultimate strength of the aerogel composite is greater than 1 MPa, greater than 10 MPa, greater than 50 MPa, greater than 100 MPa, greater than 500 MPa, greater than 1000 MPa; or less than 1000 MPa, less than 500 MPa, less than 100 MPa, less than 50 MPa, less than 10 MPa, less than 5 MPa, or less than 1 MPa. Combinations of the above noted ranges, or values outside of these ranges, are possible for the compressive ultimate strength of the polymer aerogel composite.

Thermal conductivity of an aerogel and/or aerogel composite may be measured using a calibrated hot plate (CHP) device. The CHP method is based on the principle underlying ASTM E1225 “Standard Test Method for Thermal Conductivity of Solids by Means of the Guarded-Comparative-Longitudinal Heat Flow Technique”. An apparatus in which an aerogel, polymer aerogel composite, and/or other sample material (the mass, thickness, length, and width of which have been measured as explained in the procedure for measuring bulk density) is placed in series with a standard reference material (e.g. NIST SRM 1453 EPS board) of precisely known thermal conductivity, density, and thickness, between a hot surface and a cold surface. The hot side of the system comprises an aluminum block (4″×4″×1″) with three cartridge heaters embedded in it. The cartridge heaters are controlled by a temperature controller operating in on/off mode. The set-point feedback temperature for the controller is measured at the center of the top surface of the aluminum block (at the interface between the block and the sample material) by a type-K thermocouple (referred to as TC_H). A second identical thermocouple is placed directly beside this thermocouple (referred to as TC_1). The sample material is placed on top of the aluminum block, such that the thermocouples are near its center. A third identical thermocouple (TC_2) is placed directly above the others at the interface between the sample material and the reference material. The reference material is then placed on top of the sample material covering the thermocouple. A fourth identical thermocouple (TC_3) is placed on top of the reference material, in line with the other three thermocouples. Atop this stack of materials a 6″ diameter stainless steel cup filled with ice water is placed, providing an isothermal cold surface. Power is supplied to the heaters and regulated by the temperature controller such that the hot side of the system is kept at a constant temperature of approximately 37.5° C. After ensuring all components are properly in place, the system is turned on and allowed to reach a state of equilibrium. At that time, temperatures at TC_1, TC_2, and TC_3 are recorded. This recording is repeated every 15 minutes for at least about one hour. From each set of temperature measurements (one set being the three temperatures measured at the same time), the unknown thermal conductivity can be calculated as follows. By assuming one-dimensional conduction (i.e., neglecting edge losses and conduction perpendicular to the line on which TC 1. TC 2, and TC_3 sit) one can state that the heat flux through each material is defined by the difference in temperature across that material divided by the thermal resistance per unit area of the material (where thermal resistance per unit area is defined by R″=t/k, where t is thickness in meters and k is thermal conductivity in W/m-K). The thickness, t, is measured while subjecting the sample material to a pressure equal to that which is experienced by the sample material during the CHP thermal conductivity test. For example, thickness of a sample material may be measured by sandwiching the sample material between a fixed rigid surface and a moveable rigid plate, parallel to the rigid surface, and applying a known pressure to the material sample by applying a known force to the rigid plate. Using any suitable means, for example a dial indicator or depth gauge, the thickness of this stack of materials, t_1, may be measured. The material sample is then removed from this stack of materials and the thickness, t_2, of the rigid plate is measured under the same force as previously prescribed. The thickness of the material sample under the prescribed pressure can thus be calculated by subtracting t_2 from t_1. The preferred range of material sample thickness for use in this thermal conductivity measurement is between 2 and 10 mm. Using material sample thicknesses outside of this range may introduce a level of uncertainty and/or error into the thermal conductivity calculation such that the measured values are no longer accurate and/or reliable. By setting the heat flux through the sample material equal to the heat flux through the reference material, the thermal conductivity of the sample material can be solved for (the only unknown in the equation). This calculation is performed for each temperature set, and the mean value is reported as the sample thermal conductivity. The thermocouples used can be individually calibrated against a platinum RTD, and assigned unique corrections for zero-offset and slope, such that the measurement uncertainty is ±0.25° C. rather than ±2.2° C. In certain embodiments, the thermal conductivity at 25° C. of the polymer aerogel composite, as measured by the method described herein, may be less than about 100 mW/m-K, less than about 75 mW/m-K, less than about 50 mW/m-K, less than about 35 mW/m-K, less than about 25 mW/m-K, less than about 23 mW/m-K, less than about 20 mW/m-K, or about 26 mW/m-K.

In certain embodiments, a polymer aerogel composite may pass a vertical burn test based on the procedures described in section 25.853 of the United States Federal Aviation Regulations (FAR) burn requirements for aviation interiors. The vertical burn test described in FAR 25.853 Appendix F, section (4) “Vertical Burn” was followed as written with some exceptions. The typical procedure including exceptions is as described subsequently. The sample used for the test was approximately 2.5″ in width by 3.5″ in height by 0.25″ in thickness. The sample was prepared by conditioning at ambient temperature and relative humidity, estimated to be approximately 50% relative humidity and 70° F. (21.1° C.). The flame source was a Bunsen burner using propane fuel, adjusted to approximately 1.5″ flame height. The temperature of the flame was not measured, but was the sample was hung with the shorter 2.5″ edge about 0.75″ from the top of the Bunsen burner, such that the 3.5″ edge was vertical, i.e. perpendicular to the force of gravity. The flame was applied to the sample for a period of approximately 1 minute, and then removed. The composite samples tested self-extinguished in less than about 1 second after removal of the flame. The composite samples in fact did not appear to substantially burn or sustain flame at any point, but rather charred in the presence of the flame.

In some embodiments, a screening test in which polymer aerogel composite materials are annealed at 200° C. may be performed. This temperature is indicative of the upper end of the operating temperature range for many high-temperature applications, e.g., engine cover applications. This temperature is also a point at which native polymer aerogels, e.g., polyimide aerogels, often begin to show obvious dimensional change due to temperature. After annealing at 200° C. in an oven for over 1 hour, composites may be removed and photographed. In some embodiments, polyimide aerogel composites reinforced with dispersed graphite fibers shrink to some extent non-uniformly. Without wishing to be bound to any particular theory, in some embodiments this may be related to non-uniform dispersion of the graphite fibers in the composite. In some embodiments, it may be observed that polyimide aerogel composites reinforced with poly-paraphenylene terephthalamide pulp composites also shrink and curve. In some embodiments, both poly-paraphenylene terephthalamide pulp composites and dispersed graphite fiber composites may shrink less with higher additive loadings, and both loadings may shrink less than the native aerogel material alone.

In some preferred embodiments, polymer aerogel composites reinforced with fibrous battings exhibit particularly low shrinkage and/or warping upon heating. Shrinkage measured in length, width and height as a function of temperature is shown in Table 3 for several composites. Change in density as a function of annealing temperature is shown in Table 2. For example, in some embodiments, polyimide aerogel/carbon felt composites are nearly unchanged visually after a 200° C. annealing step for 60 min as described above, and indeed only shrink 0.8% linearly from their initial size. In some embodiments, polymer aerogel/carbon felt composites may even be annealed at temperatures up to 350° C. and still exhibit low shrinkage. To evaluate whether or not the mesoporous structure and surface area of the aerogel is preserved upon annealing, nitrogen sorption porosimetry measurements may be used. In some embodiments, polyimide aerogel/carbon felt composites exhibit significant BET surface area values even after being annealed in accordance with the annealing process described above that decreases with annealing temperature. For example, a polyimide aerogel/carbon felt composite may exhibit a surface area of 187 m²/g prior to annealing, only decreasing to 137 m²/g after annealing at 200° C. and to 40 m²/g after being annealed at 350° C. for 60 min in accordance with the annealing test described above. In some embodiments, the thermal conductivity of the unannealed polyimide aerogel/carbon felt composite may be approximately 50 mW/m-K and after annealing at 350° C. increases to only around 66 mW/m-K.

In some embodiments, polymer aerogel/fibrous batting composites exhibit high-temperature mechanical stability that substantially reduces their dimensional shrinking when exposed to high temperature. For example, in some embodiments, polyimide aerogel/carbon felt composites exhibit high-temperature mechanical stability that substantially reduces their dimensional shrinking when exposed to high temperature.

In some embodiments, polyimide aerogel/carbon felt composites exhibit a flexural modulus and yield strength approximately three times greater than the native unreinforced polyimide aerogel material, with a density only 1.5 times higher than the nominal native aerogel density. Mechanical properties for representative polyimide aerogel/felt composites, the native polyimide aerogel, and an unreinforced high-strength polyurea aerogel are shown in Table 1. In addition, in some embodiments, polyimide aerogel/carbon felt composites are able to undergo large plastic deformation in flexure prior to failure.

TABLE 1
Materials properties of various polyimide aerogel/fibrous batting composites, unreinforced
polyimide aerogel, an unreinforced polyurea aerogel prior to any annealing. The polyimide
aerogel formulation used for both the composites and the unreinforced polyimide aerogel
is that which is described in Example 1. The polyurea aerogel is a higher weight
percent polymer variation of that which is described in Example 9. Mechanical properties
reported in the table are flexural unless described otherwise.

| | | | Polyimide | Polyimide | |
|---|---|---|---|---|---|
| | Native | Polyimide | Aerogel/Meta- | Aerogel/Glass | Native |
| Materials | Polyimide | Aerogel/Carbon | Aramid Felt | Felt | Polyurea |
| Property | Aerogel | Felt Composite | Composite | Composite | Aerogel |
| Density [g/cc] | 0.09 | 0.14 | 0.168 | 0.193 | 0.226 |
| Modulus [MPa] | 41.2 | 175 | 66.12 | 159 | 83.3 |
| Yield Stress [MPa] | 0.86 | 2.59 | 2.19 | 2.94 | 2.8 |
| Strain at Yield | 2.24 | 1.7 | 3.46 | 2.12 | 3.64 |
| Ultimate Strength [MPa] | 1.17 | 3.78 | 3.31 | 3.42 | 4.19 |
| Ultimate Strain [%] | 4.61 | 4.66 | 24 | 3.46 | 9.04 |

TABLE 2
Bulk density of various polyimide aerogel/fibrous batting composites
as a function of annealing temperature. The polyimide aerogel formulation
used is that which is described in Example 1. Annealing time was 60
min in an oven evenly preheated to the given temperature.

| Bulk Density | | | | | | | | | |
|---|---|---|---|---|---|---|---|---|---|
| [g/cc] | Anneal Temperature [° C.] | | | | | | | | |
| Composition | 100 | 150 | 200 | 225 | 250 | 275 | 300 | 325 | 350 |
| Polyimide Aerogel/ | 0.202 | 0.205 | 0.230 | 0.246 | 0.274 | 0.282 | 0.299 | 0.367 | 0.334 |
| Meta-Aramid Felt | | | | | | | | | |
| Composite | | | | | | | | | |
| Polyimide Aerogel/ | 0.214 | 0.219 | 0.242 | 0.262 | 0.280 | 0.291 | 0.295 | 0.284 | 0.307 |
| Silica Wool | | | | | | | | | |
| Composite | | | | | | | | | |
| Polyimide Aerogel/ | 0.175 | 0.175 | 0.200 | 0.214 | 0.232 | 0.253 | 0.263 | 0.277 | 0.309 |
| Para-Aramid Felt | | | | | | | | | |
| Composite | | | | | | | | | |
| Polyimide Aerogel/ | — | — | 0.160 | — | 0.177 | 0.180 | 0.188 | 0.190 | 0.192 |
| Carbon Felt | | | | | | | | | |
| Composite | | | | | | | | | |

TABLE 3
Percent shrinkage of sample length L, width W, and thickness T of various polyimide
aerogel/fibrous batting composites as a function of annealing temperature. The
polyimide aerogel formulation used is that which is described in Example 1. Annealing
time was 60 min in an oven evenly preheated to the given temperature.

| Percent Shrinkage | | | | | | | | | | |
|---|---|---|---|---|---|---|---|---|---|---|
| Length, Width, and | | | | | | | | | | |
| Thickness of Sample | | Anneal Temperature [° C.] | | | | | | | | |
| Composition | | 100 | 150 | 200 | 225 | 250 | 275 | 300 | 325 | 350 |
| Polyimide Aerogel/ | ΔL % | 1 | 1 | 3 | 4 | 5 | 5 | 7 | 10 | 14 |
| Meta-Aramid Felt | ΔW % | 0 | 0 | 0 | 0 | 0 | 2 | 2 | 4 | 5 |
| Composite | ΔT % | 0 | 3 | 11 | 16 | 23 | 25 | 27 | 37 | 39 |
| Polyimide Aerogel/ | ΔL % | 0 | 1 | 1 | 2 | 3 | 2 | 3 | 3 | 3 |
| Silica Wool | ΔW % | 0 | 0 | 0 | 0 | 0 | 0 | 0 | 0 | 0 |
| Composite | ΔT % | 0 | 0 | 8 | 16 | 20 | 22 | 23 | 21 | 26 |
| Polyimide Aerogel/ | ΔL % | 1 | 1 | 2 | 2 | 4 | 4 | 6 | 6 | 6 |
| Para-Aramid Felt | ΔW % | 0 | 0 | 1 | 2 | 2 | 1 | 2 | 1 | 2 |
| Composite | ΔT % | 8 | 8 | 17 | 23 | 28 | 34 | 35 | 38 | 44 |
| Polyimide Aerogel/ | ΔL % | — | — | 3 | — | 4 | 5 | 5 | 5 | 6 |
| Carbon Felt | ΔW % | — | — | 1 | — | 2 | 2 | 3 | 3 | 3 |
| Composite | ΔT % | — | — | 9 | — | 16 | 17 | 19 | 19 | 20 |

TABLE 4
Comparison of materials properties and fibrous batting costs for various polyimide aerogel/fibrous
batting composites versus polyurethane foam used in engine covers today. The polyimide
aerogel formulation used is that which is described in Example 1.

| | | | | Polyimide | Polyimide |
|---|---|---|---|---|---|
| | | | Polyimide | Aerogel/Meta- | Aerogel/Silica |
| | | Polyimide | Aerogel/Carbon | Aramid Felt | Batting |
| | PU Foam | Aerogel | Felt Composite | Composite | Composite |
| Density [g/cc] | 0.145 | 0.090 | 0.140 | 0.168 | 0.193 |
| Flexural Yield Stress [MPa] | N/A | 0.86 | 2.59 | 2.19 | 2.94 |
| Flexural Modulus [MPa] | N/A | 41 | 174 | 66 | 159 |
| Sound Transmission Loss | N/A | 12-18 | N/A | N/A | N/A |
| (1 kHz-5 kHz) [dB/cm] | | | | | |
| Thermal Conductivity | 345.4 | 23 | 50 | 28.9 | 25.7 |
| (25° C.) [mW/m-K] | | | | | |
| Maximum Operating | 225 | 300* | 325 | 250+ | 250+ |
| Temperature [° C.] | | | | | |
| Vertical Burn Test | Fail | Pass | Pass | Pass | Pass |
| Low Volume Felt Cost [$/ft²] | N/A | N/A | 40 | 12 | 7 |

In some embodiments, polymer aerogel composites exhibit low flammability and improved dimensional stability upon contact with flame compared to the native polymer aerogel. In some embodiments, when subjected to a vertical burn test above a Bunsen burner burning propane, a polyimide aerogel/carbon felt composite material is nonflammable, and does not appear to change in dimension. In some embodiments, the native polyimide aerogel subjected to the same test undergoes shrinking and warping when exposed to open flame from a Bunsen burner, whereas the only observable change in the analogous polyimide aerogel/carbon felt composite is a darkening of the polyimide aerogel material on the surface of the coupon where it was exposed to the flame.

In some embodiments, polymer aerogel composites exhibit ease of production and are cost-effective to produce. For example, samples of polyimide aerogel/carbon felt composite coupons with dimensions of 3.5″×15″×0.5″ containing intricate features have been produced through both CNC milling and direct molding with a polydimethylsiloxane (PDMS) mold. Both material samples showed very high feature resolution and validated the ease of machining and molding this material to shape, noting that molding may be a cost effective way to produce complex parts from this material in large quantities.

In some embodiments, polyimide aerogel/carbon felt composites performed well in all areas important for the application of engine covers. In some embodiments, however, a lower thermal conductivity and lower resultant cost of the composite material, which in large part is due to the high cost of the carbon felt, are desirable. Accordingly, other fibrous battings may be used instead of carbon felt to reduce cost and/or thermal conductivity of polymer aerogel composites. In some embodiments, a poly-metaphenylene isophthalamide felt, e.g., Nomex brand felt, may be used. In some embodiments, a silica-based insulation batting, e.g., fiberglass, may be used. In some embodiments, such alternate fibrous batting materials may be substantially less expensive than carbon felt. In some embodiments, polyimide aerogel composites prepared with such battings may exhibit unannealed thermal conductivities as low as about 26 mW/m-K at room temperature, almost 50% lower than that of the analogous carbon felt composite. In some embodiments, the mechanical properties and temperature stability properties of both the poly-metaphenylene isophthalamide and silica felt composites are nearly comparable to those of the analogous carbon felt composite, as shown in Table 1. In some embodiments, polymer aerogel composites prepared with poly-metaphenylene isophthalamide felt, while slightly lower in modulus and yield stress than analogous silica and carbon felt composites, exhibit a unique behavior in that even under very large strains, the material does not undergo any noticeable brittle failure. Even under repeated folding of the material, while the aerogel in the bending region appeared to compress substantially, the composite material did not tear. In some embodiments, a 6.0-cm×2.0-cm×0.5-cm coupon of the composite can be bent completely in half onto itself, i.e., folded over on itself 180°, without breaking.

In some embodiments, polymer aerogels reinforced with fibrous battings, e.g., the felt materials described herein, are very promising for applications including engine cover materials and in other applications needing high-temperature structural insulation.

Key mechanical and thermal properties of several polymer aerogel/fibrous batting composites are shown in Table 4 and compared to polyurethane foam material currently used in engine covers. In some embodiments, polymer aerogel composites incorporating chopped graphite fiber and/or poly-paraphenylene phthalamide pulp may have other, lower-temperature applications that only require improved mechanical reinforcement or perhaps other properties that these materials exhibit which materials reinforced by felts do not.

As used herein, the “maximum operating temperature” is given its ordinary meaning in the art, and refers to the temperature above which the article undergoes substantial chemical and/or mechanical degradation. Examples of chemical degradation include denaturing, decomposition, phase change, and ignition. Examples of mechanical degradation include mechanical warping, falling apart, and the like.

In some embodiments, the maximum operating temperature refers to the temperature above which the article falls apart.

In some embodiments, the maximum operating temperature refers to the temperature above which the article fails to retain its structural integrity.

In some embodiments, the maximum operating temperature refers to the temperature above which the article ignites (i.e., catches on fire) in air.

In some embodiments, the maximum operating temperature refers to the temperature above which the article changes phase (e.g., melts, evaporates, and/or sublimates).

In some embodiments, the maximum operating temperature refers to the temperature above which the article continues to lose mass even once reaching thermal equilibrium.

Polymer aerogel composites may be prepared in a variety of form factors. In some embodiments, monolithic parts may be produced. One of ordinary skill in the art would appreciate the meaning of monolithic as referring to a whole, contiguous, macroscopic part or object as opposed to, for example, a powdered or granular form of a material, a sub-volume of a part or object, or an embedded/integrated component of a material, e.g., one of the networks in an aerogel comprising interpenetrating networks.

In some embodiments, the part may have complex features. In some embodiments, linear tapes may be produced. In some embodiments, the shape of a polymer aerogel composite may be changed by CNC milling, sawing, drilling, stamping, sanding, grinding, bending, and/or thermoforming.

In some embodiments, the fibrous batting comprises a carbon felt. In some embodiments, the carbon felt exhibits a bulk density of about 0.08 g/cc, an areal weight of 530 g/m², and electrical resistivity of less than 4 Q-mm. In some embodiments, the carbon felt comprises at least about 95 wt % carbon. In some embodiments, the carbon felt comprises ex-PAN carbon.

In some embodiments, a polymer aerogel composite has desirable materials properties for engineering applications. In some embodiments, a polymer aerogel composite with an operating temperature greater than about 100° C., greater than about 200° C., greater than about 250° C., greater than about 300° C., greater than about 325° C., and/or greater than about 350° C., can be produced. In some embodiments, the polymer aerogel composite does not ignite in air at any temperature below 100° C., at any temperature below 200° C., at any temperature below 250° C., at any temperature below 300° C., at any temperature below 325° C., or at any temperature below 350° C. In some embodiments, for at least one dimension of the polymer aerogel composite, the dimension does not change by more than 20%, by more than 10%, by more than 5%, or by more than 2% at any temperature below 100° C., at any temperature below 200° C., at any temperature below 250° C., at any temperature below 300° C., at any temperature below 325° C., or at any temperature below 350° C. In some embodiments, the dimensions of the polymer aerogel composite after exposure to temperatures about 200° C. fall within about 2%, within about 5%, within about 10%, or within about 20% of the dimensions of the aerogel composite prior to exposure to said temperatures. In some embodiments, the dimension of the polymer aerogel composite after exposure to temperatures about 250° C. fall within about 2%, within about 5%, within about 10%, or within about 20% of the dimensions of the aerogel composite prior to exposure to said temperatures. In some embodiments, the dimensions of the polymer aerogel composite after exposure to temperatures about 300° C. fall within about 2%, within about 5%, within about 10%, or within about 20% of the dimensions of the aerogel composite prior to exposure to said temperatures. In some embodiments, the dimensions of the polymer aerogel composite after exposure to temperatures about 350° C. fall within about 2%, within about 5%, within about 10%, or within about 20% of the dimensions of the aerogel composite prior to exposure to said temperatures. In some embodiments, when exposed to the maximum operating temperature for the first time, the polymer aerogel composite undergoes irreversible one-time linear shrinkage of less than about 20%, less than about 15%, less than about 10%, or less than about 5%. In some embodiments, the polymer aerogel composite undergoes irreversible one-time linear shrinkage of less than about 20%, less than about 15%, less than about 10%, or less than about 5% when exposed to flame. In some embodiments, the surface area of the polymer aerogel composite is greater than about 10 m²/g, greater than about 20 m²/g, greater than about 40 m²/g, greater than about 60 m²/g greater than about 80 m²/g, greater than about 100 m²/g, greater than about 150 m²/g, greater than about 200 m²/g, greater than about 250 m²/g, greater than about 300 m²/g, greater than about 350 m²/g, greater than about 400 m²/g, greater than about 600 m²/g, or greater than about 800 m²/g. In some embodiments, after exposure to its maximum operating temperature the surface area of the polymer aerogel composite is greater than about 10 m²/g, greater than about 20 m²/g, greater than about 40 m²/g, greater than about 60 m²/g greater than about 80 m²/g, greater than about 100 m²/g, greater than about 150 m²/g, greater than about 200 m²/g, greater than about 250 m²/g, greater than about 300 m²/g, greater than about 350 m²/g, greater than about 400 m²/g, or greater than about 600 m²/g, greater than about 800 m²/g. In some embodiments, the flatness of the monolithic polymer aerogel composite changes less than about 1%, less than about 2%, less than about 3%, less than about 4%, less than about 5%, less than about 6%, less than about 7%, less than about 8%, less than about 9%, or less than about 10% relative to its flatness when exposed to the maximum operating temperature. In some embodiments, the flatness of the monolithic polymer aerogel composite changes less than about 1%, less than about 2%, less than about 3%, less than about 4%, less than about 5%, less than about 6%, less than about 7%, less than about 8%, less than about 9%, or less than about 10% relative to its initial flatness, when exposed to the maximum operating temperature. In some embodiments, the thickness of the monolithic polymer aerogel composite changes less than about 1%, less than about 2%, less than about 3%, less than about 4%, less than about 5%, less than about 6%, less than about 7%, less than about 8%, less than about 9%, or less than about 10% relative to its initial thickness, when exposed to the maximum operating temperature. In some embodiments, polymer aerogel composites exhibit low thermal conductivities at room temperature and/or temperatures above room temperature. In some embodiments, the thermal conductivity of the polymer aerogel composite is less than about 150 mW/m-K, less than about 100 mW/m-K, less than about 90 mW/m-K, less than about 80 mW/m-K, less than about 70 mW/m-K, less than about 60 mW/m-K, less than about 50 mW/-K, less than about 40 mW/m-K, less than about 30 mW/m-K, or less than about 20 mW/m-K at room temperature. In some embodiments, polymer aerogel composites exhibit high sound transmission loss values and/or low speed of sound values. In some embodiments, polymer aerogel composites are suitable for use as soundproofing, a component in a ballistics shield and/or bullet-proof armor, and/or vibration mitigating insulation. In some embodiments, the sound transmission loss of the polymer aerogel composite is greater than about 1 dB/cm, greater than about 5 dB/cm, greater than about 10 dB/cm, greater than about 11 dB/cm, greater than about 12 dB/cm, greater than about 13 dB/cm, greater than about 14 dB/cm, greater than about 15 dB/cm, greater than about 16 dB/cm, greater than about 17 dB/cm, greater than about dB/cm, greater than about 18 dB/cm, greater than about 19 dB/cm, greater than about 20 dB/cm, greater than about 30 dB/cm, greater than about 40 dB/cm, and/or greater than about 50 dB/cm. In some embodiments, the polymer aerogel composite is nonflammable. In some embodiments, the composite conforms to the specifications of FAR 25.853. In some embodiments, the flexural yield stress of the polymer aerogel composite is greater than about 0.5 MPa, greater than about 1 MPa, greater than about 1.5 MPa, greater than about 2 MPa, greater than about 2.5 MPa, greater than about 3 MPa, greater than about 3.5 MPa, or greater than about 4 MPa. In some embodiments, the flexural modulus of the polymer aerogel composite is greater than about 20 MPa, greater than about 50 MPa, greater than about 100 MPa, greater than about 150 MPa, greater than about 200 MPa, greater than about 250 MPa, greater than about 300 MPa, or greater than about 400 MPa. In some embodiments, the polymer aerogel composite can undergo flexural strain of greater than 1%, greater than 5%, greater than 10%, greater than 20%, greater than 30%, greater than 40%, greater than 50%, greater than 60%, greater than 70%, or greater than 80% without fracture. In some embodiments, the bulk density of the polymer aerogel composite is less than about 0.3 g/cc, less than about 0.25 g/cc, less than about 0.2 g/cc, less than about 0.15 g/cc, less than about 0.1 g/cc, or less than about 0.5 g/cc. In some embodiments, the mass fraction of aerogel in the composite is greater than about 10%, greater than about 20%, greater than about 30%, greater than about 40%, greater than about 50%, greater than about 60%, greater than about 70%, greater than about 80%, or greater than about 90%. In some embodiments, the polymer aerogel composite is used in a vehicle. In some of these embodiments, the vehicle is an automobile, an airplane, a rocket, and/or a boat. In some embodiments, the polymer aerogel composite is used in an engine cover. In some embodiments, a vehicle engine cover comprising a fibrous batting and polymer aerogel may be made.

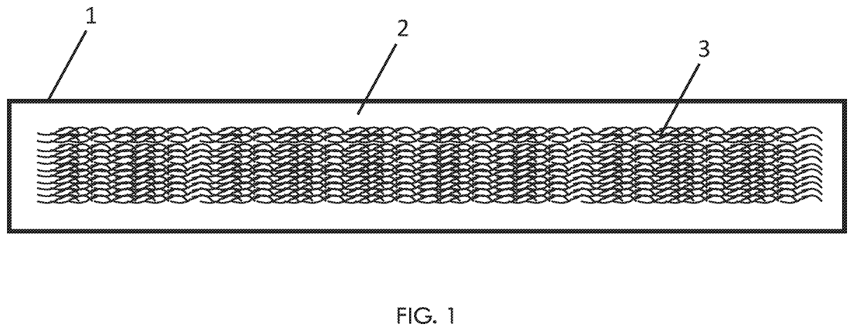

FIG. 1 depicts a cross-sectional schematic illustration of a composite, according to certain embodiments. The schematic shows an aerogel composite 1 comprising a polymer aerogel 2 and a fibrous batting 3 located at least partially within the outer bounds of the polymer aerogel. In some preferred embodiments the polymer aerogel comprises a polyimide. In some embodiments the fibrous batting comprises a carbon felt, a meta-aramid felt, a para-aramid felt, a polyester felt, or a silica fiber batting.

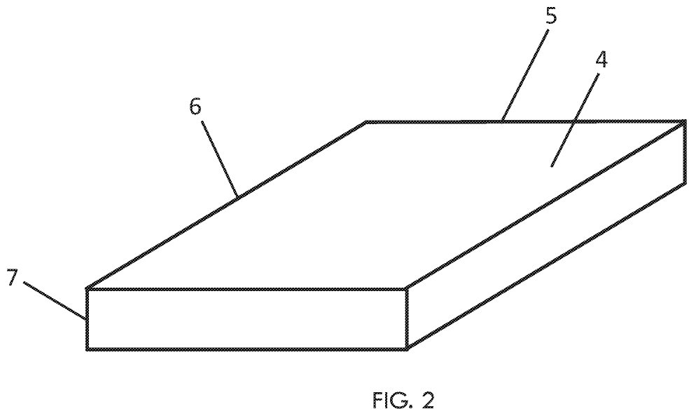

FIG. 2 depicts a perspective view of an aerogel composite 4 with dimensions of length 5, width 6, and thickness 7 in accordance with certain embodiments. In some embodiments, the aerogel composite comprises the shape of a plate, a block, a rod, a disc, a cylinder, a cube, a tape, or a sphere. One of ordinary skill in the art would recognize that the shape of the aerogel composite part can be described by certain characteristic linear dimensions as shown in the schematic.

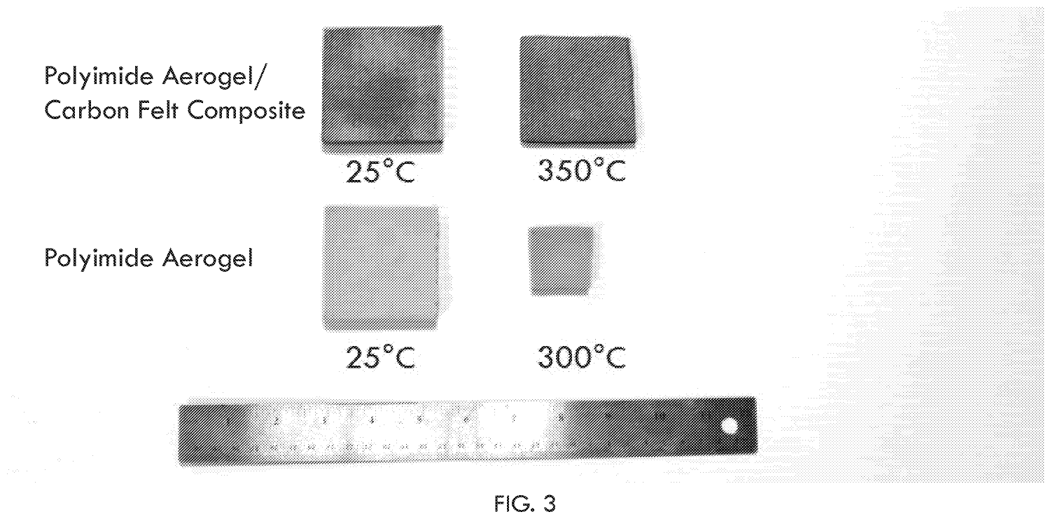

FIG. 3 depicts an polymer aerogel composite before and after heating to 350° C. and a polymer aerogel reference material (i.e., the same formulation of aerogel used in producing the composite) before and after heating to 300° C. in accordance with certain embodiments. The polymer aerogel is the polyimide aerogel material described in Example 1. One of ordinary skill in the art would recognize that the dimensions of the aerogel composite after heating are more similar to the dimensions of the aerogel composite before heating than those of the heated reference material are to the unheated reference material. One of ordinary skill in the art would recognize that this means the composite material shrunk less than the reference material when heated.

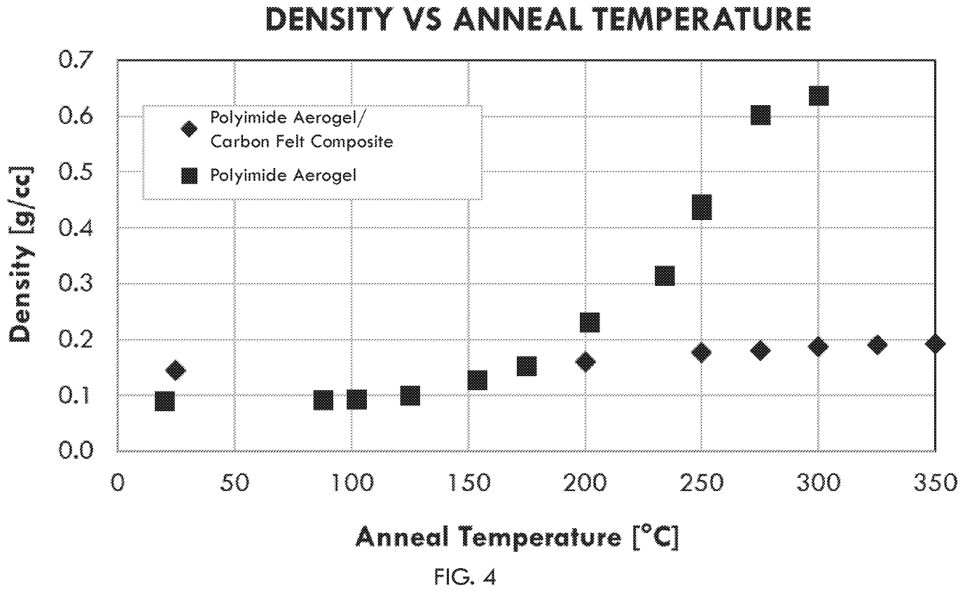

FIG. 4 is a graph of bulk density vs. annealing temperature for a polymer aerogel composite and the reference unreinforced polymer aerogel material shown in FIG. 3 in accordance with certain embodiments. The graph shows that the aerogel composite (referred to as polyimide aerogel/carbon felt composite) increases in density from approximate 0.15 g/cc at 25° C. to approximately 0.20 g/cc at 300° C., while the unreinforced reference material (referred to as polyimide aerogel) increases from approximate 0.09 g/cc at 25° C. to approximately 0.65 g/cc at 300° C. The polymer aerogel was the polyimide aerogel described in Example 1.

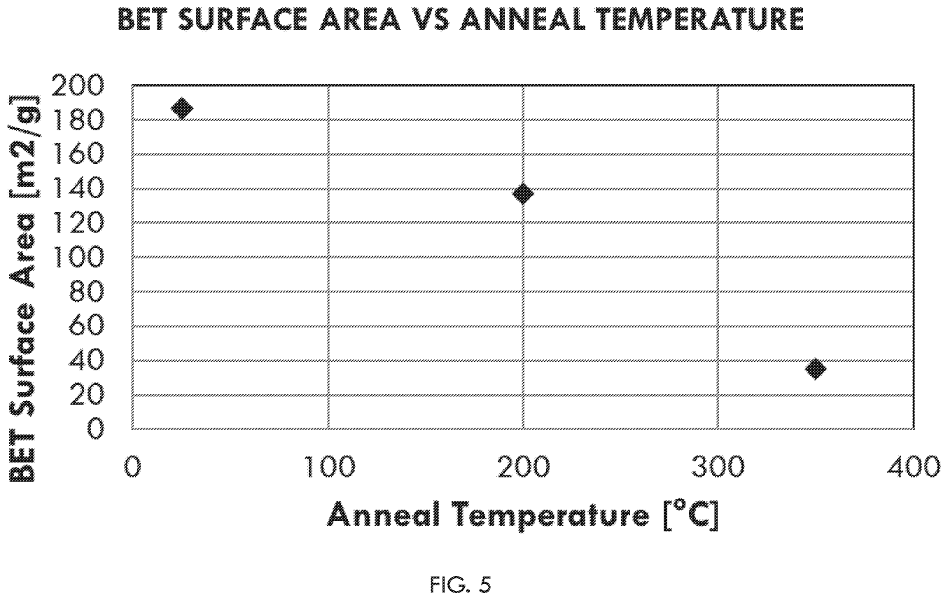

FIG. 5 is a graph showing the specific surface area of a polymer aerogel composite vs. the temperature at which it was annealed in accordance with certain embodiments. One of ordinary skill in the art would appreciate that the specific surface area decreases at higher annealing temperature. However, even after exposure to 350° C. the composite retains nearly 40 m²/g specific surface area. One of ordinary skill in the art would appreciate that this indicates that the mesoporous structure of the original aerogel is preserved to some extent. The polymer aerogel is the polyimide aerogel material described in Example 1.

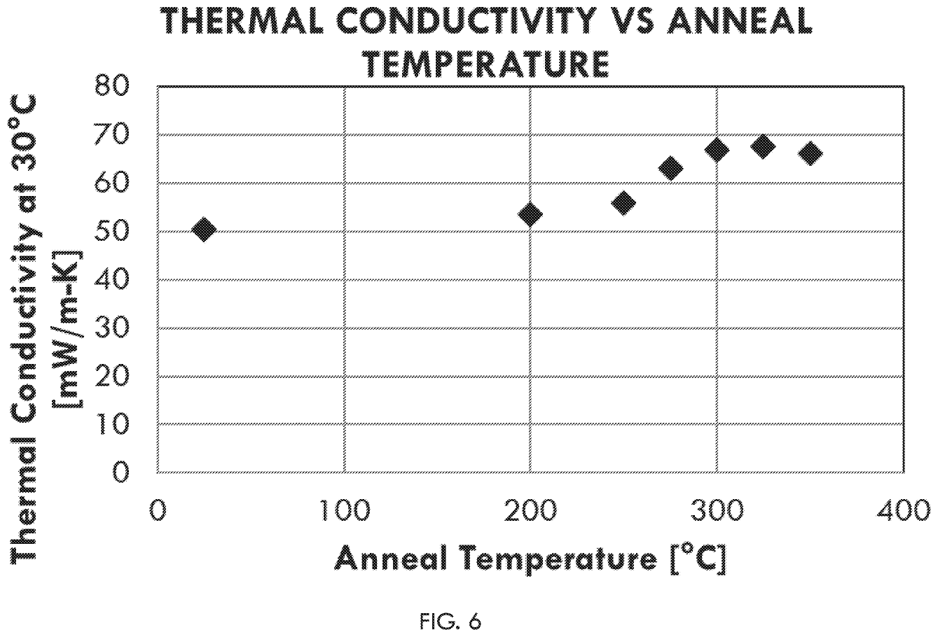

FIG. 6 is a graph of thermal conductivity at room temperature vs. the temperature at which the sample was annealed for a polyimide aerogel/carbon felt composite in accordance with certain embodiments. The thermal conductivity of the sample increases only by approximately 10% after annealing the sample at 250° C., relative to the thermal conductivity of the unannealed sample. The polymer aerogel is the polyimide aerogel material described in Example 1.

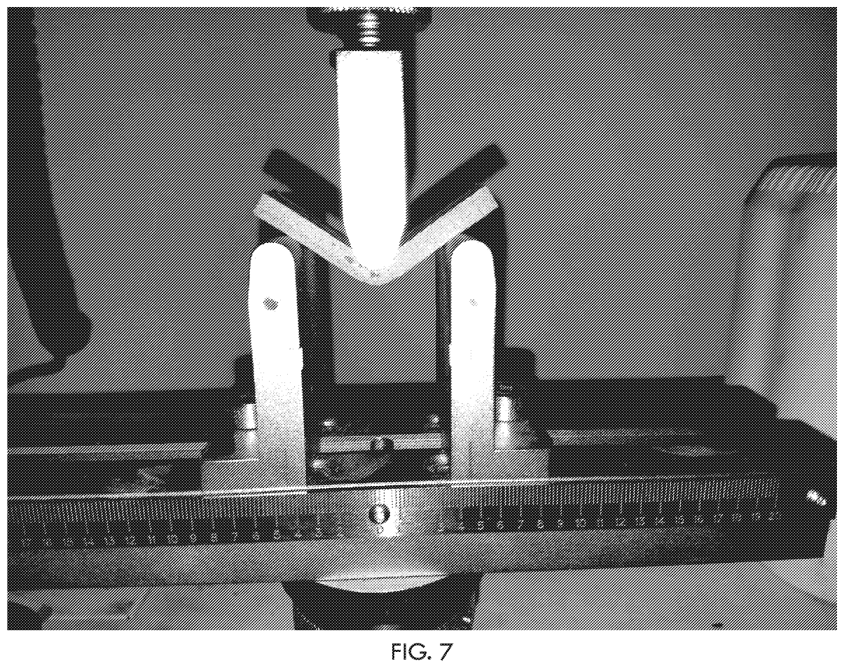

FIG. 7 is an image of a polymer aerogel composite during mechanical flexure testing in the jaws of a three-point-bend fixture in accordance with certain embodiments. This image demonstrates the large flexural strains that the composite is capable of withstanding without fracture.

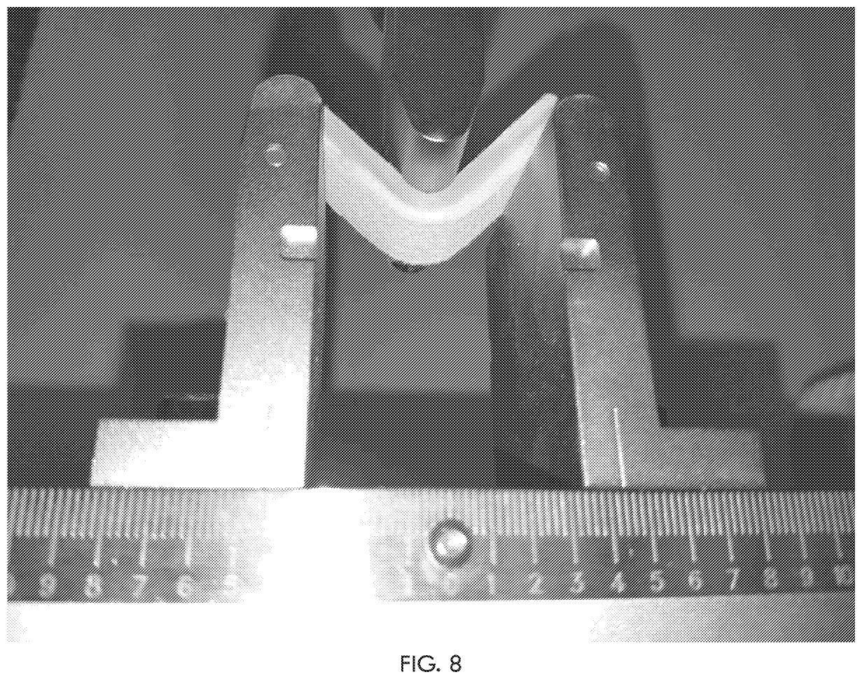

FIG. 8 is also an image of a polymer aerogel/meta-aramid felt composite during mechanical flexure testing in the jaws of a three-point-bend fixture, shown from a vantage point below the fixture in accordance with certain embodiments. This figure shows that in this type of composite, there is no evident cracking or separation on the bottom side of the sample even after large tensile strains.

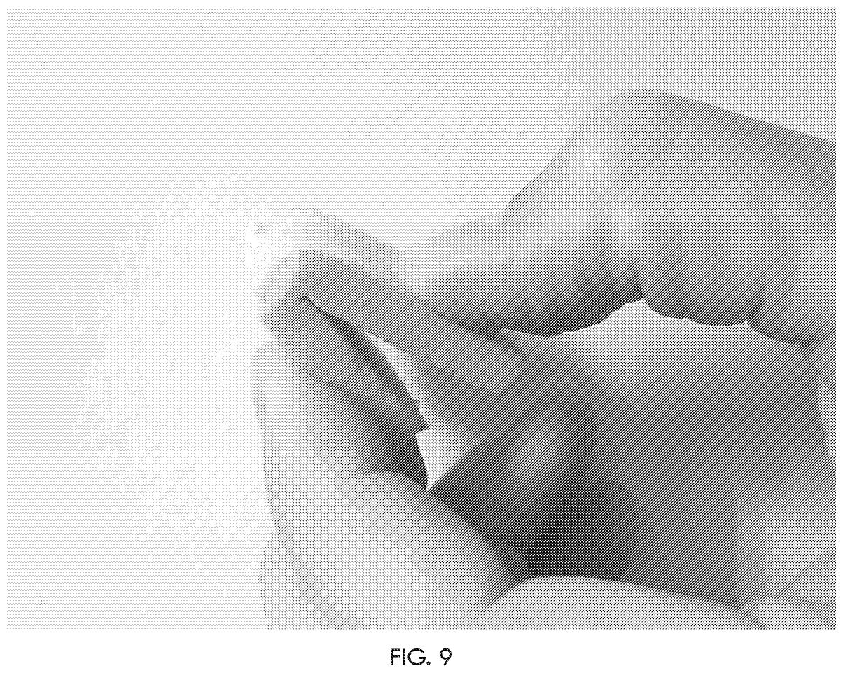

FIG. 9 is an image of a polymer aerogel/meta-aramid felt composite during mechanical flexure that is induced by a human hand in accordance with certain embodiments. This figure shows that in this type of composite, even at a thickness of approximately 5 mm or more, the material may be fully bent in half, without fracturing the bulk composite material. The meta-aramid felt remains fully intact at the location of the bend, and the aerogel within the composite is compressed to accommodate the small radius of curvature of the composite.

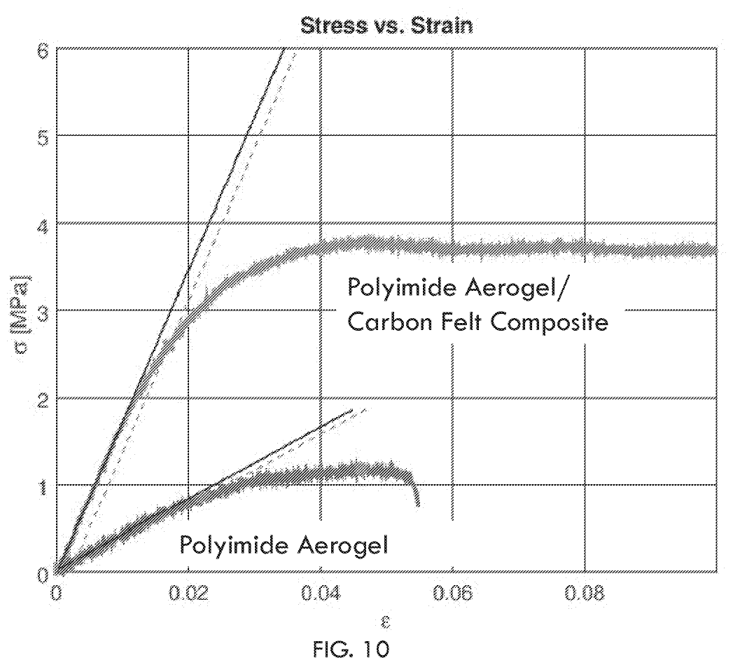

FIG. 10 is a graph of the stress vs. strain curve for the outer member of two samples in flexure, namely a polyimide aerogel/carbon felt composite and an unreinforced polyimide aerogel equivalent to that contained within the composite in accordance with certain embodiments. One of ordinary skill in the art would appreciate that the flexural modulus and flexural yield strength of the composite are both substantially higher than for the aerogel only. In addition, one of ordinary skill in the art would appreciate that the degree of ductility, that is, the region of plastic strain subsequent to yield but prior to brittle failure, of the composite is much larger than the degree of ductility for the aerogel only. The polymer aerogel is the polyimide aerogel material described in Example 1.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### EXAMPLES

The following examples are intended to illustrate certain embodiments of the present invention, but do not exemplify the full scope of the invention.

### Example 1. Synthesis of a Polymer Aerogel Composite Comprising Polyimide Aerogel Derived from Amine and Anhydride and Carbon Felt Prepared Via Supercritical CO₂ Drying

A polyimide aerogel was synthesized by reaction of an amine and an anhydride. 0.54 g 4,4′-oxydianiline (ODA) was dissolved in 26.13 mL N-methyl-2-pyrrolidone (NMP). The mixture was stirred until the ODA was fully dissolved (no particulates visible). 1.63 g 3,3′,4,4′-biphenyltetracarboxylic dianhydride (BPDA) was added. After stirring for 10 minutes, 0.58 g 2,2′-dimethylbenzidine was added, and the mixture was stirred for an additional 10 minutes. The resulting sol was comprised of anhydride-terminated polyamic acid oligomers. In parallel, a crosslinking solution of 0.04 g 1,3,5-tris(aminophenoxy)benzene (TAB) dissolved in 5 mL NMP was prepared. After 10 minutes this crosslinking mixture was added to the primary mixture and stirred for an additional 10 minutes. 4.54 g acetic anhydride was added, followed immediately by 1.12 g triethylamine. The sol was stirred for an additional 10 minutes before being poured into a rectangular polyethylene mold with internal dimensions of 93 mm by 65 mm, containing a 6-mm thick piece of carbon felt (non-woven carbon felt AvCarb C200, purchased from fuelcellstore.com, part number 1595016, density of 0.08 g/cc, nominal felt thickness of ¼″) which filled the entire areal dimensions of the mold. The mold containing the sol-saturated carbon felt was then covered and allowed to age for 12-18 hours at ambient conditions. Gelation of the sol occurred within one hour.

After the gel/felt composite was aged, it was removed from the mold and transferred to a sealed container partially filled with approximately 400 mL acetone and was submerged in the acetone to perform a solvent exchange of the gel pore liquor with acetone. It remained in the container for 72 hours, during which time the acetone was decanted and replaced with an equivalent volume of new acetone twice.

After the solvent exchange with acetone was complete, the gel/felt composite was transferred to a supercritical drying pressure vessel and submerged in excess acetone. The pressure vessel was sealed and liquid CO₂ was introduced into the pressure vessel.

The CO₂-acetone mixture was drained periodically while simultaneously supplying fresh liquid CO₂, until all the acetone was removed. Then, the pressure vessel was isolated from the CO₂ supply while still filled with liquid CO₂. The pressure vessel was heated until the internal temperature reached 54° C., during which time pressure increased.

Pressure was regulated by actuation of a solenoid valve, and was not allowed to exceed 1400 psi. The CO₂ inside the vessel was at that time in the supercritical state, and was held at these conditions for three hours, at which point the autoclave was slowly vented isothermally, such that the supercritical fluid entered the gaseous state without forming a two-phase liquid-vapor system, until the pressure vessel returned to atmospheric pressure. The pressure vessel was finally cooled to room temperature before the aerogel composite was retrieved.

The composite material produced in this way had a density of 0.14 g/cc, flexural modulus of 175 MPa, flexural yield stress of 2.59 MPa, and thermal conductivity of 50 mW/m-K at 25° C.

A sample of the aerogel composite with dimensions of 6.5 cm×2.0 cm×0.5 cm, initially at a temperature of 25 deg. C., was transferred from an environment at 25 deg. C. and 1 atm pressure of air into an evenly-heated oven at a temperature of 200 deg. C. and 1 atm pressure of air and was left in the oven for a period of 60 minutes. After heating the length, width and thickness of the sample decreased by 3%, 1%, and 9%, respectively.

In some embodiments, anhydride-terminated polyamic acid oligomers were crosslinked by reacting the anhydride with one or more polyfunctional crosslinkers other than TAB, in which the polyfunctional crosslinker comprises at least one functional groups reactive towards anhydride and at least one functional groups reactive towards another crosslinker molecule.

In some embodiments, the molar ratio of amine to anhydride in the polyimide synthesis was adjusted to generate a sol containing amine-terminated polyamic acid oligomers. These were then crosslinked by replacing TAB with a different polyfunctional crosslinker with functional groups that react with amines (e.g., acyl chloride or isocyanate).

### Example 2. Synthesis of a Polymer Aerogel Composite Comprising Polyimide Aerogel

Derived from Amine and Anhydride and Meta-Aramid Felt Prepared via Supercritical CO₂ Drying A composite was made according to the procedure outlined in Example 1, however using a meta-aramid felt (Nomex® meta-aramid needled non-woven felt, purchased from thefeltstore.com, part number beginning in F-INVNOMEX, density of approximately 0.085 g/cc, nominal felt thickness of ¼″) in place of carbon felt. The density of the resulting composite was 0.168 g/cc. The composite had a flexural modulus of 66.12 MPa, flexural yield stress of 3.46 MPa, and thermal conductivity of 28.9 mW/m-K at 25° C.

A sample of the aerogel composite with dimensions of 6.5 cm×2.0 cm×0.5 cm, initially at a temperature of 25 deg. C., was transferred from an environment at 25 deg. C. and 1 atm pressure of air into an evenly-heated oven at a temperature of 200 deg. C. and 1 atm pressure of air and was left in the oven for a period of 60 minutes. After heating the length, width and thickness of the sample decreased by 3%, 0%, and 11%, respectively.

### Example 3. Synthesis of a Polymer Aerogel Composite Comprising Polyimide Aerogel

Derived from Amine and Anhydride and Silica Batting Prepared via Supercritical CO₂ Drying A composite was made according to the procedure outlined in Example 1, however using a fibrous silica batting (non-woven silica insulation, purchased from McMaster-Carr, part #93435K41, approximate density of 0.16 g/cc) in place of carbon felt. The density of the resulting composite is 0.193 g/cc. The composite had a flexural modulus of 159 MPa and a flexural yield stress of 2.94 MPa. A sample of the aerogel composite with dimensions of 6.5 cm×2.0 cm×0.5 cm, initially at a temperature of 25 deg. C., was transferred from an environment at 25 deg. C. and 1 atm pressure of air into an evenly-heated oven at a temperature of 200 deg. C. and 1 atm pressure of air and was left in the oven for a period of 60 minutes. After heating the length, width and thickness of the sample decreased by 1%, 0%, and 8%, respectively.

### Example 4. Synthesis of a Polymer Aerogel Composite Comprising Polyimide Aerogel

Derived from Isocyanate and Anhydride and Meta-Aramid Felt Prepared via Supercritical CO₂ Drying A polyimide gel was synthesized by reaction of isocyanate and anhydride. The synthesis was performed in an inert nitrogen atmosphere. 17.44 g 3,3′,4,4′-benzophenonetetracarboxylic dianhydride was combined with 380 g dimethylformamide and stirred until the 3,3′,4,4′-benzophenonetetracarboxylic dianhydride was fully dissolved, which took approximately 10 minutes. To this mixture, 49.21 g Desmodur RE solution (27 wt % tris(isocyanatophenyl)methane in ethyl acetate) was added, and the combined mixture was stirred for 10 minutes. After 10 minutes, 1.7 g polydimethylsiloxane was optionally added and the mixture was stirred for an additional 5 minutes. The mixture was then poured into molds containing meta-aramid felt as described in Example 2. The sol-soaked felts were covered but not completely gas-tight (to avoid pressurization during heating), and placed in a temperature-controlled environment in which the air temperature was kept at 70° C. for 3.5 hours. The gel/felt composites were then allowed to sit for 12 hours at room temperature. After 12 hours, the gel/felt composites were transferred to a solvent exchange bath containing acetone, and further processed into aerogel/felt composites as described in Example 1.

### Example 5. Synthesis of a Polymer Aerogel Composite Comprising Polyurea Aerogel

Derived from Isocyanate and Water and Meta-Aramid Felt Prepared via Supercritical CO₂ Drying A polyurea gel was synthesized from reaction of an isocyanate with water. 158.12 g Desmodur N3300 (isocyanurate of hexamethylene diisocyanate) was dissolved in 592.3 g acetone and stirred until homogenous (approximately 15 minutes). To this mixture was added 11.14 g deionized water and the mixture was stirred for 5 minutes.

Finally, 0.762 g triethylamine was added to the mixture, and the mixture was stirred for an additional 5 minutes. The resulting sol mixture was them poured into molds containing meta-aramid felt as described in Example 2. The molds were then sealed in a gas-tight container, and transferred to a controlled-temperature environment which was set to 15° C. The molds were allowed to sit for 24 hours, during which time gelation occurred. After 24 hours, the gel/felt composites were removed from their molds and transferred to a solvent exchange bath containing acetone, and processed further into aerogel/felt composites as described in Example 1.

### Example 6. Synthesis of a Polymer Aerogel Composite Comprising Polyimide Aerogel

Derived from Amine and Anhydride and Carbon Felt Prepared via Atmospheric-Pressure Freeze Drying from Organic Solvent with Dry Air A polyimide gel/felt composite was synthesized using the procedure described in Example 1 up until the solvent exchange step. After aging, rather than transferring the gel to acetone, it was transferred to a bath of tert-butanol, i.e., tert-butyl alcohol. The volume of the alcohol bath was five times that of the gel. The alcohol in the bath was replaced 5 times, once every 24 hours. The bath was maintained at 40° C. throughout solvent exchange. After solvent exchange, the gel/felt composites were placed in a sealed bag and transferred to a cold chamber maintained at 10° C. for 12 hours to freeze the solvent.

The gel/felt composite was then removed from the bag and transferred to a temperature-controlled drying chamber. The gel/felt composite was placed in the drying chamber on a scaffold that thermally isolated it from the walls of the chamber and allowed for unimpeded gas flow on all sides of the gel/felt composite. Gas was supplied at one end of the chamber and exhausted at the opposite end causing gas to constantly flow over and around the gel/felt composite. Temperature of the inlet gas was measured inside the drying chamber by a thermocouple placed directly downstream from the inlet port.

The gas in this case was desiccated compressed air. Air was supplied by a compressor at 100 psi. The regulated gas flow rate was controlled using a needle valve and the resultant flow rate of 25 SCFH measured using a gas-flow rotameter. After passing through the rotameter, the gas flowed through a liquid-cooled finned heat exchanger. The heat exchanger was cooled using a recirculating chiller, which pumped a cooled mixture of water and ethylene glycol, and was operated at a temperature and flow rate sufficient to maintain a drying chamber temperature of 0° C. as measured by the thermocouple at the inlet of the drying chamber. The effluent gas from the drying chamber (a mixture of nitrogen and tert-butanol vapor) passed through a cold trap designed to capture tert-butanol vapor. The remaining nitrogen gas was then vented to the atmosphere through a standard air exhaust system.

Over the course of the drying process the gel/felt composite was optionally periodically removed from the drying chamber and its mass was measured before quickly returning it to the drying chamber (before remaining tert-butanol within the gel could begin to melt). The mass of the drying gel/felt composite was thus tracked over time and when this mass ceased to change from one measurement to the next, the resulting aerogel/felt composite was considered to be completely dry.

### Example 7. Synthesis of a Polymer Aerogel Composite Comprising Polyimide Aerogel

Derived from Amine and Anhydride and Meta-Aramid Felt Prepared via Subcritical CO₂ Drying A gel/felt composite comprising polyimide gel and meta-aramid felt was prepared as described in Example 2 until the step after the pressure vessel containing liquid CO₂ was isolated from the CO₂ tank. At that point, instead, the vessel was heated to 28° C. Pressure was regulated using the same manner as described in Example 2, but was limited to 1000 psi as to never exceed the critical point of CO₂. After dwelling at these conditions for three hours, the pressure vessel was depressurized isothermally so that the surface tension of the liquid phase was minimized, thereby reducing drying stress exerted on the solid skeleton of the porous gel. Once the vessel reached atmospheric pressure, it was allowed to return to room temperature before the final polyimide/felt composite was retrieved.

### Example 8. Synthesis of a Polymer Aerogel Composite Comprising Polyimide Aerogel

Derived from Amine and Anhydride and Meta-Aramid Felt Prepared via Evaporative Drying from Low-Surface Tension Solvent A polyimide gel/felt composite was synthesized using the procedure described in Example 1. After solvent exchanging into acetone, the gel/felt composite was solvent exchanged further into ethoxynonafluorobutane. The volume of the solvent bath was approximated five times that of the gel, and the solvent was replaced five times, once every 24 hours.

Finally, the gel/felt composites were dried by removing them from the low-surface-tension fluorinated organic solvent bath and allowing the solvent to evaporate from the gels at atmospheric pressure and room temperature, resulting in an aerogel/felt composite material comprising polyimide aerogel and meta-aramid felt.

### Example 9. Synthesis of Polyurea Aerogel with a Density of 0.166 g/cc Produced from

Reaction of Isocyanate with hI-Situ-Formed Amine A polyurea gel was synthesized from the reaction of an isocyanate with water. 26.54 g Desmodur N3300 (isocyanurate trimer of hexamethylene diisocyanate) was dissolved in 158.35 g acetone and stirred until homogenous (approximately 15 minutes).

To this mixture 1.87 g deionized water was added and the mixture was stirred for 5 minutes. Finally 0.26 mL triethylamine was added to the mixture and the mixture was stirred an additional 5 minutes. The sol was poured into a mold which was then sealed in a gas-tight container and transferred to a temperature-controlled environment set to 15° C. The gel was allowed to sit for 24 hours, during which time gelation occurred.

After 24 hours the gel was removed from the mold and transferred to a solvent exchange bath.

### Example 10. Synthesis of Aromatic Polyurea Aerogel

An aromatic polyurea gel was synthesized by reaction of an amine and an isocyanate. 1.8 g oligomeric methylene diphenyl diisocyanate (Lupranat® M20) was dissolved in 12 g ethyl acetate in a glass beaker while stirring at 20° C. In another beaker 1.6 g 3,3′,5,5′-tetramethyl-4,4′-diaminophenylmethane and 0.1 g N,N′,N″-tris(dimethylaminopropyl)-s-hexahyrotriazine were dissolved in 12.5 g ethyl acetate.

The contents of the two beakers were mixed and allowed to rest at room temperature for 24 hours. After 24 hours the gel was removed from its mold and transferred to a solvent exchange bath.

### Example 11. Synthesis of Polyamide Aerogel

A polyamide aerogel was prepared from reaction of TPC/IPC/mPDA, with n=30 and 7.5 w/w %. A solution of mPDA (6.832 g, 63.200 mmol) in NMP (179.96 ml) was cooled to 5° C. using an ice water bath. Isophthaloyl chloride (6.207 g, 30.573 mmol) was added in one portion as a solid and the cooled solution was allowed to stir for 30 minutes. Solid terephthaloyl chloride (6.832 g, 63.200 mmol) was then added and the solution was allowed to stir for an additional 30 minutes. Solid 1,3,5-benzenetricarbonyltrichloride (0.360 g, 1.356 mmol) was added and the mixture was vigorously stirred for 5 minutes before being poured into 25 mL syringe molds lined with Teflon. Gelation occurred within 5 minutes. After aging overnight at room temperature, the monoliths were removed from the molds and placed in 500 mL jars of ethanol in order to exchange the reaction solvent, N-methylpyrrolidone. The solvent in the containers was replaced with fresh ethanol at 24 hour intervals to ensure that all of the NMP was removed from the gels. The gels were then subjected to supercritical CO₂ extraction followed by drying (75° C.) in a vacuum oven overnight. The resulting aerogel had a density of 0.12 g/cm³.

1. An aerogel composite, comprising:
a polymer aerogel; and
a fibrous batting located at least partially within outer bounds of the polymer aerogel;
wherein, when a sample of the aerogel composite with dimensions of 6.5 cm×2.0 cm×0.5 cm and/or the aerogel composite itself, initially at a temperature of 25 deg. C., is transferred from an environment at 25 deg. C. and 1 atm pressure of air into an evenly-heated oven at a temperature of 200 deg. C. and 1 atm pressure of air and is left in the oven for a period of 60 minutes, a length of at least one dimension of the sample and/or the aerogel composite does not shrink or shrinks by less than 10% relative to its length prior to the heating.

2. An aerogel composite, comprising:
a polyimide aerogel; and
a fibrous batting located at least partially within outer bounds of the polyimide aerogel;
wherein the polyimide aerogel comprises a polyimide oligomer component, and
wherein the polyimide oligomer component is connected to another polyimide oligomer component by a crosslinker.

3. A method of making an aerogel composite, comprising:
removing liquid from a gel within which a fibrous batting is at least partially contained to form an aerogel composite comprising a polymer aerogel and the fibrous batting;
wherein, when a sample of the aerogel composite with dimensions of 6.5 cm×2.0 cm×0.5 cm and/or the aerogel composite itself, initially at a temperature of 25 deg. C., is transferred from an environment at 25 deg. C. and 1 atm pressure of air into an evenly-heated oven at a temperature of 200 deg. C. and 1 atm pressure of air and is left in the oven for a period of 60 minutes, a length of at least one dimension of the sample and/or the aerogel composite does not shrink or shrinks by less than 10% relative to its length prior to the heating.

4. (canceled)

5. The aerogel composite of claim 2, wherein the aerogel composite is at least 6.5 cm×2.0 cm×0.5 cm in size.

6. The aerogel composite of claim 5, wherein, when a sample of the aerogel composite with dimensions of 6.5 cm×2.0 cm×0.5 cm, initially at a temperature of 25 deg. C., is transferred from an environment at 25 deg. C. and 1 atm pressure of air into an evenly-heated oven at a temperature of 200 deg. C. and 1 atm pressure of air and is left in the oven for a period of 60 minutes, a length of at least one dimension of the sample does not shrink or shrinks by less than 10% relative to its length prior to the heating.

7. The aerogel composite of claim 6, wherein at least two orthogonal dimensions of the sample do not shrink or shrink by less than 10% relative to their lengths prior to the heating.

8. The aerogel composite of claim 6, wherein three orthogonal dimensions of the sample do not shrink or shrink by less than 10% relative to their lengths prior to the heating.

9. The aerogel composite of claim 6, wherein at least one dimension of the sample does not expand or expands by less than 10% relative to its length prior to the heating.

10. The aerogel composite of claim 9, wherein at least two orthogonal dimensions of the sample do not expand or expand by less than 10% relative to their lengths prior to the heating.

11. The aerogel composite of claim 10, wherein three orthogonal dimensions of the sample do not expand or expand by less than 10% relative to their lengths prior to the heating.

12. The aerogel composite of claim 1, wherein the aerogel composite is smaller than 6.5 cm×2.0 cm×0.5 cm in size.

13. The aerogel composite of claim 2, wherein, when the aerogel composite, initially at a temperature of 25 deg. C., is transferred from an environment at 25 deg. C. and 1 atm pressure of air into an evenly-heated oven at a temperature of 200 deg. C. and 1 atm pressure of air and is left in the oven for a period of 60 minutes, a length of at least one dimension of the composite does not shrink or shrinks by less than 10% relative to its length prior to the heating.

14. The aerogel composite of claim 1, wherein at least two orthogonal dimensions of the composite do not shrink or shrink by less than 10% relative to their lengths prior to the heating.

15. The aerogel composite of claim 1, wherein three orthogonal dimensions of the sample do not shrink or shrink by less than 10% relative to their lengths prior to the heating.

16. The aerogel composite of claim 1, wherein at least one dimension of the composite does not expand or expands by less than 10% relative to its length prior to the heating.

17. The aerogel composite of claim 1, wherein at least two orthogonal dimensions of the composite do not expand or expand by less than 10% relative to their lengths prior to the heating.

18. The aerogel composite of claim 1, wherein three orthogonal dimensions of the composite do not expand or expand by less than 10% relative to their lengths prior to the heating.

19. The aerogel composite of claim 1, wherein at least 50 wt % of the fibrous batting is within the outer boundaries of the polymer aerogel.

20. The aerogel composite of claim 1, wherein at least 99 wt % of the fibrous batting is at or within the outer boundaries of the polymer aerogel.

21. The aerogel composite of claim 1, wherein at least one dimension of the aerogel composite is greater than 10 cm in length.

22-106. (canceled)
